(19) United States
(12) Patent Application Publication
(10) Pub. No.: US 2022/0267607 A1
(43) Pub. Date: Aug. 25, 2022

(54) COMPOSITE MATERIALS

(71) Applicant: Anaphite Limited, Bristol (GB)

(72) Inventors: Sam Burrow, Bristol (GB); Elena Mogort-Valls, Bristol (GB); Conor Brady, Bristol (GB); Thomas Bryant, Bristol (GB); Vaiva Nagyte, Bristol (GB); Mehrdad Alibouri, Bristol (GB)

(21) Appl. No.: 17/631,169

(22) PCT Filed: Jul. 31, 2020
(86) PCT No.: PCT/EP2020/071740

§ 371 Date: Jan. 28, 2022

(30) Foreign Application Priority Data
Jul. 31, 2019 (GB) 1910948.7

(51) Int. Cl. C09C 1/46; C08K 9/04; C08J 5/00; C01B 32/182

(52) U.S. Cl. CPC C09C 1/46; C08K 9/04; C08J 5/005; C01B 32/182

(57) ABSTRACT

The present invention relates to processes for forming composites. The invention also relates to composites obtained by the processes described herein. Also provided are composites comprising 2D materials.

The present invention relates to processes for forming composites. The invention also relates to composites obtained by the processes described herein. Also provided are composites of 2D materials.

### BACKGROUND

Exfoliation of graphite and other layered produces two-dimensional (2D) materials with interesting physical, electronic and catalytic properties. Forming composites of such materials is of great interest.

Paton et al., Nature Materials 13 pp. 624-630 (2014) describe scalable production of defect-free few-layer graphene by shear exfoliation in liquids.

CN-A-106492777 discloses a graphene oxide/titanate nanotube composite photocatalyst wherein graphene oxide and nano titania nanoparticles are subjected to solvothermal reaction, thus obtaining a graphene oxide/titanate nanotube composite photocatalyst.

CN-A-106337276 discloses a preparation method of a chitosan fabric based on graphene foam modification. The preparation method comprises soaking the chitosan fabric in a graphene oxide solution.

CN-A-105944709 discloses a three-dimensional graphene and nano-meter titania composite photocatalyst and a preparation method thereof. The method comprises providing a nickel foam which is soaked in an aqueous graphene oxide solution to obtain a three-dimensional graphene oxide material which is then soaked in a titanium tetrachloride solution.

CN-A-103285845 discloses a preparation method of a graphene oxide wrapped titania microsphere photocatalyst involving monodisperse titania microspheres undergoing an esterification condensation reaction with graphene oxide.

CN-A-102600823 discloses a preparation method for a graphene/titania composite material, which comprises preparing a precursor solution of graphene oxide and titania, heating and stirring. The graphene oxide can subsequently be reduced by microwave heating, thus avoiding the use of toxic reductants.

There is a demand for high concentrations of graphene to be formed in polymer materials via methods that avoid the evaporation of graphene-polymer mixtures. The evaporation of graphene-polymer mixtures typically leads to aggregation of graphene sheets.

Youn et al, Scientific Reports volume 5, Article number: 9141 (2015) demonstrates the use of a monomer/oligomer which has a low viscosity at higher temperatures, enabling good dispersion of high concentrations of graphene to be reached within the composite. Aggregation is avoided by performing in-situ polymerisation with a solvent-free process.

Typically, graphene loadings are limited to ˜2-15% by weight due to diminishing returns on increased loadings. Such diminishing returns are due to poor distribution of graphene in the polymer matrix, typically caused by either: A) high viscosity of the melted composite limiting sufficient dispersion and mixing of graphene sheets within the polymer, or B) aggregation of previously dispersed graphene sheets caused by poor stabilisation of graphene sheets.

One widely used approach is to use a solvent-based system to mix graphene sheets and a dissolved polymer together, followed by a solvent removal step to solidify the polymer and entrap the graphene within the polymer matrix.

It is thought that the process of evaporating the graphene dispersion solvent from the system is a significant factor in aggregation, due to the preference of graphene's interaction with the solvent, and relatively strong pi-stacking interactions between graphene sheets. Such solvents are normally well-matched to the surface energies of graphene. For example, in the case of pristine/non-functionalised graphene, solvents such as THF, DMSO, or others are used, which can dissolve polymers and disperse graphene, allowing them to mix. While the solvent evaporates, the graphene sheets can migrate through the (still solubilised) polymer bulk to form aggregates.

Aggregated graphene is disadvantageous as it reduces the mechanical properties of the composite, as less surface area is available to interact with the polymer, and the breakdown/separation of aggregates under composite strain leads to hysteresis (a well-studied effect in carbon black-filled rubbers).

Graphene can be modified to include functional groups on its edges or surface, which facilitate better interaction with polymer systems to avoid aggregation and permit better mixing. However, such modification can be costly, time-consuming, and can interfere with the pristine nature of graphene sheets, reducing conductivity.

Unfortunately, none of the known methods provide a simple and flexible process for production of a composite material with minimal additional process steps.

There is a need for a universal, flexible process to produce composite materials between layered 2D materials and particulate materials. Herein is presented a method suitable for a wide range of solvents, 2D materials, and particulate materials. Unlike methods previously disclosed, this method is highly scalable, rapid, and does not rely on covalent bonds between materials. Instead, a method based on flocculation is presented.

The prior art demonstrates some examples to produce composites between 2D and particulate materials.

For metal oxides, most common is the ‘in-situ precipitation’ method. where metal oxide precursor salts are added to a dispersion of 2D material, and the metallic salts precipitated onto the 2D material by decomposition, or reaction with the 2D material surface, or addition of another reactant which initiates formation of metal oxides. This method also requires that graphene be dispersed in the precipitation media, which prohibits or limits the use of particular solvent combinations which can be used to tailor the size and shape of metallic particles, a critically important consideration. When graphene is used as a 2D material, graphene oxide is most often used as a source of graphene, as it is easily dispersed in the aqueous systems that are most commonly used for metal oxide formation. The use of graphene oxide is undesired as it contains many defects/oxygen-containing chemical groups, which interfere with the electrical conductivity of the graphene sheets. Complete removal of defects normally requires separate processing steps, or high temperatures and pressures which are undesirable for a commercial product.

For polymers, most common is the ‘in-situ polymerisation’ where monomer(s) and initiator is added into a dispersion of 2D sheets. This is challenging to perform reliably, as the behavior of polymers as they are grown around the surface of 2D materials is different from that in solution, leading to issues with inhomogeneity and molecular weight broadening. This method also requires that graphene be well-dispersed in the polymerisation media, which restricts scale-up and use of environmentally friendly solvents (i.e. in water-based polymerisation). In addition, evaporation of the solvent can cause migration of the 2D material or polymer, leading to aggregation of the 2D material and a limitation on the concentration of 2D material reached.

It is preferable to have a composite material with inter-particle attachment between components. This helps to ensure that the composite is, and remains, homogeneous. A mixture without attachment between 2D and particulate materials is undesired, as the interaction between 2D material and particulate materials (e.g. polymer/metallic oxides) is usually limited, due to large differences in typical surface polarity. Upon removal of the mixing solvent by filtration or centrifugation or evaporation, the particulate and 2D material can easily separate and aggregate separately from one another. This is especially an issue considering that large volumes of solvent are normally needed to disperse 2D materials. To remedy this, the interaction between the particles is typically increased by the addition of surfactants, or the functionalisation or chemical bridging of the 2D and/or the particulate material. One popular example of pre-treatment of 2D materials is the use of acids and oxidising agents (c.f. ‘The Hummers Method’ for graphene) to add carbon-oxygen functional groups which increase the polarity of the 2D material surface—these polar bonds can be covalently or non-covalently reacted directly to the particulate surface or via the use of chemical bridging agents.

Despite the benefits in composite homogeneity when compared to simple mixing, these methods suffer from multiple scalability and quality issues. For example, the presence of surfactants may interfere with electrical conductivity of the end product, and require additional washing steps to remove. Furthermore, the oxidation or functionalisation disrupts the pristine sheet layers of 2D materials, which can adversely affect the electrical and physical properties of the end product. For example, reduced graphene oxide (RGO), which is graphene that has been oxidised, then ‘reduced’ to remove oxygen, has far lower conductivity than pristine graphene (i.e. chemically unmodified graphene) due to the addition of sheet defects from reaction of the oxidising agent with carbon atoms. The multiple steps needed with these methods inhibit scale-up, and add additional undesirable variables to a product. For example, in the case of graphene, variations in the initial source of graphite can drastically change the electrical and chemical properties of RGO (https://www.sciencedirect.com/science/article/pii/S2211379718317820). Partial functionalisation of pristine graphene sheets to facilitate better mixing in composites is a growing field, but the functionalisation usually must be tailored to each material, and understanding the detailed nature of the functionalisation is extremely difficult without extraordinarily difficult techniques like TERS (Tip Enhanced Raman Spectroscopy). More flexible, rapid, and cheap methods of making composites between 2D materials and particulate materials are needed.

Stable water suspensions of graphene are useful for dispersing graphene in latexes of different polymers, especially rubber latex. However, the addition of a surfactant alters the final composition and properties of the composites. Surfactants may the attainment of better colloidal stability to prepare rGO/natural rubber composites which may improve the electrical conductivity of natural rubber, however, the elongation at the break reduces drastically and microdomains caused by residue of the surfactant in rubber composites could act as defect centers and producing the failure of the materials under mechanical stress. Aguilar-Bolados and et al. eliminated SDS surfactant from NR/rGO composite films using washing process with distilled water for 72 h under stirring which it is too time consuming for large-scale use. [Removal of Surfactant from Nanocomposites Films Based on Thermally Reduced Graphene Oxide and Natural Rubber, J. Compos. Sci. 2019, 3, 31; doi:10.3390/jcs3020031]

Surfactant-free graphene will play an important role in future application in electronics, as the presence of surfactants on the surface of graphene significantly impacts its electrical properties. There is a strong desire to eliminate the use of surfactants in graphene-based materials. [https://doi.org/10.1016/j.mseb.2019.01.003]

Studies on other solution-processed 2D materials have been reported already. One 2D material branch is TMDs (Transition Metal Dichalcogenide) layered compounds. They consist of individual layers in a basic form of XMX (or MX2), where M is a metal atom from the IVB, VB, and VIB periodic groups and X is a chalcogen atom (S, Se, or Te). Depending on the metal species, the electronic structure can be metallic (VB), semiconducting or insulating (IVB and VIB). 2D materials with different physical or chemical properties than graphene can be advantageous. For example, a material with a band gap, in some instances, is more preferable than graphene, as graphene is a semimetal without a band gap. Thus, the required on/off current ratio cannot be achieved in electronic applications with graphene. A band gap is essential for many photovoltaic, transistor applications. For instance, Xing Gu et al. demonstrated ‘A Solution-Processed Hole Extraction Layer Made from Ultrathin MoS2 Nanosheets for Efficient Organic Solar Cells’ where power conversion efficiency of 4.03% and 8.11% was achieved when MoS2 nanosheets act as the hole-extraction layer. Moreover, insulating properties of 2D materials can be employed for barrier purposes. Various physical or chemical properties, in addition to the 2-dimensional nature of materials (high surface area, transparency due to the nanometer thickness), show the broad range of possibilities to utilise non-graphene 2D layered materials in diverse applications. Similarly to graphene, methods to both a) accommodate for the extremely low concentration of layered TMDs in solvents and b) form well-mixed composites of TMDs and other materials are highly desired.

### BRIEF SUMMARY OF THE INVENTION

### 1. The Formation of Composites Using Non-Basic Salts

In a first aspect there is provided a process for forming a composite, the process comprising the following steps:

a) providing a 2D material in a solvent;

b) adding a particulate material to the solvent;

c) providing a flocculating agent in the solvent, wherein the flocculating agent is a non-basic flocculating salt;

wherein the presence of the flocculating agent in the solvent causes an interaction between the particulate material and 2D material to form a composite. Surprisingly, the invention provides a reliable process of rapidly forming homogeneous composites of 2D materials and particulate materials.

### 1.1. 2D Materials of the First Aspect

The 2D material used in the first aspect may be graphene-based or an inorganic layered material.

The 2D layered material of the first aspect may be selected from:
graphene, graphene oxide, reduced graphene oxide, functionalised graphene, partially oxidised graphene (i.e. i.e. graphene with an oxygen content less than 15% that has not been reduced from graphene oxide or preferably graphene with an oxygen content less than 10 atom % that has not been reduced from graphene oxide);
metal oxide nanosheets which are composed of sheets of edge/corner sharing MO₆ octahedra, (where M is a transition metal, and O is oxygen), where the sheets are separated by alkali metal cations, protons, water, solvent or any combination thereof;
metal double hydroxides which are composed of octahedral hydroxide layers of divalent and trivalent metal cations, where charge is balanced with anions between the layers, represented by the general formula M²⁺₁₋ₓM³⁺ₓ(OH)₂Aⁿ⁻_{x/n}.mH₂O (where M²⁺=Mg²⁺, Fe²⁺, Co²⁺, Ni²⁺, Zn²⁺, etc.; M³⁺=Al³⁺, Fe³⁺, Co³⁺, etc.; and A=(CO₃)²⁻, Cl⁻, (NO₃)⁻, (ClO₄)⁻, etc.);
hexagonal boron nitride;
transition metal dichalcogenides with the general stoichiometry MX₂, where M is a transition metal atom and X is a chalcogen atom, (e.g. MoS₂, WS₂, MoTe₂, MoSe₂ etc.); or
any other layered 2D material consisting of less than 4 elements in a compound, less than 40 atoms in the primitive cell, covalently bonded in-plane and held out-of-plane by weak intermolecular forces.

Preferably, the 2D material is not graphene oxide or reduced graphene oxide. In certain embodiments, the 2D material in the first aspect is not graphene or a graphene-based material.

Suitably, the 2D material is selected from graphene, partially oxidised graphene, (i.e. graphene with an oxygen content less than 15 atom %, or preferably graphene with an oxygen content less than 10 atom % that has not been reduced from graphene oxide), halogenated graphene, hexagonal boron nitride (hBN), 2D metal oxides, 2D metal hydroxides, and transition metal dichalcogenides (e.g. MoS₂, WS₂, MoTe₂, MoSe₂).

Surprisingly and advantageously, the present invention does not require any functionalisation of the 2D materials in order to form composites.

Suitably, the 2D material is selected from hBN, graphene or a transition metal dichalcogenide. Suitably, the 2D material is graphene or graphene with an oxygen content less than 15 atom %. Suitably, the 2D material is graphene with a FWHM Raman peak of less than 60 cm⁻¹.

The non-basic flocculating salt may be an acidic salt or a neutral salt. Thus, when the flocculating salt of the first aspect is added to deionised water, it results in a solution with a pH of 7 or less, or 7.5 or less.

Suitably, one or more non-basic flocculating salts may be utilised in the process of the invention. Thus, a combination of non-basic flocculating salts may be utilised.

The non-basic flocculating salt may be selected from alkali hydrogen phosphate, ethyltriphenylphosphonium halides, Borax, non-basic ammonium salts, tetraethylammonium halides, alkaline earth metal nitrates, alkali metal nitrates, alkaline earth metal halides, alkali metal halides, MOF precursors (such as those disclosed herein) and combinations thereof.

Suitably, the non-basic flocculating salt is selected from one or more of:
a. non-basic alkali metal phosphates, sulphates, halides, and nitrates;
b. non-basic alkaline earth metal phosphates, sulphates, halides, and nitrates; or
c. non basic complexes of organic coordinating salts with transition metal centres (Generally classed as MOFs).

Suitably, the non-basic flocculating salt is selected from one or more of a non-basic alkaline earth metal phosphate, a non-basic alkali metal phosphate, a non-basic alkaline earth metal sulphate, a non-basic alkali metal sulphate, a non-basic alkaline earth metal halide, or a non-basic alkali metal halide, a non-basic alkaline earth metal nitrate, or a non-basic alkali metal nitrate. A skilled person will be familiar with which of such salts would be non-basic.

Suitably, the non-basic flocculating salt is one or more of sodium hydrogen phosphate, Ethyltriphenylphosphonium iodide, Borax, ammonium acetate, ammonium chloride, tetraethylammonium bromide, magnesium nitrate, lithium chloride, sodium chloride, ammonium thiocyanate, metal organic frameworks (MOFs), zinc nitrate, diaminobutane, 2-methylimidazole, Li2SO4, Na2SO4, K2SO4, copper chloride, iron (II) chloride, iron (III) chloride, potassium carbonate, potassium persulfate, tripotassium phosphate, salts of acetic acid, ammonium thiocyanate and combinations thereof.

Suitably, the flocculating salt that is non-basic is one or more of sodium hydrogen phosphate, Ethyltriphenylphosphonium iodide, Borax, ammonium acetate, tetraethylammonium bromide, magnesium nitrate, lithium chloride, sodium chloride, ammonium thiocyanate, MOF precursors, zinc nitrate, diaminobutane, 2-methylimidazole, and combinations thereof.

In certain embodiments, the flocculating agent comprises a MOF precursor disclosed herein. The use of such precursors allows the formation of composites comprising a metal organic framework.

Most suitably, the non-basic flocculating salt is one or more of sodium chloride, ammonium acetate, zinc nitrate, 2-methylimidazole.

In certain embodiments of the present invention, the non-basic flocculating salt is not ammonium chloride. In certain embodiments, if the non-basic flocculating salt is ammonium chloride, it is formed in-situ in the solvent (e.g. by the addition of ammonia and hydrochloric acid to the solvent). In certain embodiments of the present invention, the non-basic flocculating salt is not monosodium citrate or disodium citrate.

Suitably, the 2D material may be made “in-situ” in the processes of the first aspect. This is achieved by exfoliating a bulk multi-layered material (e.g. graphite, boron nitride or a TMDC) in the solvent. The bulk multi-layered material required to produce the analogous 2D material will be known to those skilled in the art. Suitable bulk layered materials include but are not limited to graphite, partially oxidised graphite, boron nitride, molybdenum disulphide, molybdenum diselenide, tungsten disulphide etc. Forming a 2D material in-situ is advantageous because it reduces the number of steps required to form a composite.

The exfoliation may be performed in the presence of one or both of the particulate material and the non-basic flocculating salt.

Thus, in an embodiment, the process of the first aspect comprises:
a) providing a dispersion of a bulk layered material in a solvent;
b) adding a particulate material to the dispersion;
c) exfoliating the layered material, before or after the addition of the particulate material, to form a 2D material in the dispersion;
   wherein the process comprises introducing a flocculating agent that is a non-basic flocculating salt into the dispersion prior to or following any one of steps a) to c); wherein the presence of the flocculating salt in the solvent causes an interaction between the particulate material and 2D material to form a composite. The non-basic flocculating salt may be added prior to exfoliation or added after exfoliation. Similarly, the non-basic flocculating salt may be added prior to addition of the particulate material or after addition of the particulate material.

The 2D material may be pre-prepared and added directly to the solvent without the need for exfoliation. Thus, in another embodiment, the process of the first aspect comprises:

a) providing a dispersion of a 2D material in a solvent;

b) adding a particulate material to the dispersion;

wherein the process comprises introducing a flocculating agent that is a non-basic flocculating salt into the dispersion prior to or following any one of steps a) or b); wherein the presence of the flocculating salt in the solvent causes an interaction between the particulate material and 2D material to form a composite. Surprisingly, this process is found to form a composite between the two materials despite the prior stabilisation of the 2D material in the ready-made dispersion.

The flocculating agent may be provided as part of a ready-made dispersion of 2D material. Thus, in another embodiment, the process of the first aspect comprises:

a) providing a dispersion of a 2D material and a flocculating agent that is a non-basic flocculating salt in a solvent;

b) adding a particulate material to the dispersion;

wherein the presence of the flocculating agent in the solvent results in the interaction between the particulate material and 2D material to form a composite. Surprisingly, this process is found to form a composite between the two materials despite the prior stabilisation of the 2D material in the ready-made dispersion.

The non-basic flocculating salt may be present in the solvent prior to the addition of the 2D material.

### 2. The Formation of Composites Using Basic Materials

In a second aspect, there is provided a process for forming a composite, the process comprising the following steps:

a) providing a 2D material that is not graphene-based in a solvent;

b) adding a particulate material to the solvent;

c) providing a flocculating agent in the solvent, wherein the flocculating agent is a basic material;

wherein the presence of the flocculating agent in the solvent results in the interaction between the particulate material and 2D material to form a composite. Surprisingly, the invention provides a reliable method of rapidly forming homogeneous composites of non-graphene 2D materials and particulate materials.

The embodiments described in relation to the first aspect may also be applicable to the embodiments of the second aspect. In the embodiments of the second aspect, the non-basic flocculating salt utilised in the first aspect will be replaced with the basic material utilised in the second aspect. Also, in embodiments of the second aspect, the 2D material will be a 2D material that is not graphene-based (i.e. a material that is not graphene, graphene oxide, reduced graphene oxide or any form of functionalised graphene). Modifications of the processes of the first aspect to be applicable to those of the second aspect are contemplated in the present application.

### 2.1. 2D Materials of the Second Aspect

The 2D material that is not graphene-based will suitably be an inorganic 2D layered material. The 2D material that is not graphene-based may be thought of as an inorganic material in the context of the present invention

The 2D layered material may be selected from one or more of:
metal oxide nanosheets which are composed of sheets of edge/corner sharing MO₆ octahedra, (where M is a transition metal, and O is oxygen), where the sheets are separated by alkali metal cations, protons, water, solvent or any combination thereof;
metal double hydroxides which are composed of octahedral hydroxide layers of divalent and trivalent metal cations, where charge is balanced with anions between the layers, commonly represented by the general formula M²⁺₁₋ₓM³⁺ₓ(OH)₂Aⁿ⁻_{x/n}.mH₂O (whereM²⁺=Mg²⁺, Fe²⁺, Co²⁺, Ni²⁺, Zn²⁺, etc.; M³⁺=Al³⁺, Fe³⁺, Co³⁺, etc.; and A=(CO₃)²⁻, Cl⁻, (NO₃)⁻, (ClO₄)⁻, etc.);
hexagonal boron nitride;
transition metal dichalcogenides with the general stoichiometry MX₂, where M is a transition metal atom and X is a chalcogen atom, (e.g. MoS₂, WS₂, MoTe₂, MoSe₂ etc.); or
any other layered 2D material consisting of less than 4 elements in a compound, less than 40 atoms in the primitive cell, covalently bonded in-plane and held out-of-plane by weak intermolecular forces

Suitably, the 2D material is selected from hexagonal boron nitride (hBN), 2D metal oxides, 2D metal hydroxides, and transition metal dichalcogenides (e.g. MoS₂, WS₂, MoTe₂, MoSe₂).

Most suitably, the 2D material is selected from hBN or a transition metal dichalcogenide.

The 2D materials described in relation to the second aspect may also be utilised in the first aspect.

The basic material may be a Brønsted base and/or a Lewis base. The basic material may be a base, i.e. basic solution.

The basic material may be considered as a “source of base” e.g. a solid or liquid material which when added to deionised water results in a basic solution. The source base may be a flocculating salt that is basic.

The source of base may comprise a source of hydroxide ions, for example, the source of hydroxide ions may comprise an ion exchange resin, a basic ammonia-based salt solution or, preferably, an alkali solution, in particular a solution of sodium hydroxide and/or potassium hydroxide. Other choices of hydroxide ions may be chosen in different cases, to maximise the quality or properties of the end-product. For example, in applications requiring high ionic purity, like Li-ion batteries, a solution of lithium hydroxide may be used. Alternatively, a volatile base such as ammonium carbonate may be used, which is easily removed from the finished composite with mild heating and/or low pressure. Where the particulate is a metal oxide, the source of hydroxide may preferably be provided at an amount of 0.5 millimoles to 20 millimoles per 10 g of metal oxide, preferably per 10 g titanium dioxide (where titanium dioxide is the particulate material).

The base may also be provided at a weight percentage of 0.1% to 800% of the weight of the particulate material. Preferably, the base is provided at 5%-300% of the weight of the particulate material. Even more preferably, the base is provided at 10%-75% of the weight of the polymer or metal oxide material. The amount of base may be increased to increase the rate of settling and the homogeneity of the final composite.

The basic material of the second aspect may be selected from one of more of sodium hydroxide, aluminium hydroxide, potassium hydroxide, lithium hydroxide, saturated calcium hydroxide solution (in the form of limewater), ammonium sulphide, sodium citrate, ammonium carbonate, sodium pyruvate, sodium citrate, potassium citrate, lithium citrate, and other organic bases. Suitably, the basic material of the second aspect may be selected from one of more of sodium hydroxide, potassium hydroxide, lithium hydroxide, saturated calcium hydroxide solution (in the form of limewater), ammonium sulphide, sodium citrate, ammonium carbonate, sodium pyruvate, sodium citrate, potassium citrate, lithium citrate and other organic bases.

Suitably, the basic material of the second aspect is a basic flocculating salt selected from one or more of:
a. basic alkali metal phosphates, sulphates, halides, nitrates, carbonates;
b. basic alkaline earth metal phosphates, sulphates, halides, nitrates and carbonates; or
c. basic complexes of organic coordinating salts with transition metal centres (Generally classed as MOFs).

Suitably, the basic flocculating salt is selected from one or more of a basic alkaline earth metal phosphate, a basic alkali metal phosphate, a basic alkaline earth metal sulphate, a basic alkali metal sulphate, a basic alkaline earth metal halide, or a basic alkali metal halide, a basic alkaline earth metal nitrate, or a basic alkali metal nitrate. A skilled person will be familiar with which of such salts would be basic.

The basic material of the second aspect may be selected from one of more of a basic alkaline earth metal phosphate, a basic alkali metal phosphate, a basic alkaline earth metal sulphate, or a basic alkali metal sulphate.

In the second aspect of the invention, combinations of basic and/or non-basic salts may be used in certain embodiments to ensure consistency of pH of a system. For example, some metal oxides may dissolve in high or low pH. As non-limiting example, Sodium aluminate is used as a source of aluminium hydroxide; it is the sodium hydroxide salt of aluminium hydroxide, and is soluble in water. Upon treatment with equimolar amounts of acid (e.g. HCl), sodium aluminate is neutralised to form NaCl and Al(OH)₃. The Al(OH)₃ salt is highly insoluble in water. The Al(OH)₃ may be used as a flocculating agent to generate a composite material (see example 20).

In the context of the second aspect of the invention, alkali metal and alkaline earth metal carbonates may be formed by providing a source of CO2 (e.g. sodium carbonate or CO2 gas), and a source of alkali metal or alkaline earth metal ions. In some conditions known to those skilled in the art, a carbonate or bicarbonate salt may formed.

Suitably, the base is a saturated ammonium carbonate solution. Ammonium carbonate can be removed from the final composite material by mild heating. This enables the production of composites with very high purity. Other volatile or labile bases or basic salts such as ammonium sulphide, or other basic ammonium, amine-based, or nitrogen-containing salts and mixtures thereof may be used when appropriate.

In some embodiments, a base may be added before the exfoliation of the bulk layered material. Additional base may be added following exfoliation, to further improve the interaction between the exfoliated 2D material and the particulate.

Suitably, for the preparation of polymer composites, especially when using polymer dispersions stabilised at pH>7 as the source of polymer, saturated calcium hydroxide solution may be used as the base. Without wishing to be bound by theory, it is believed that the solubility of calcium hydroxide reduces with increasing pH, forming charged particles that help bring the flocculated product out of solution.

The basic material may be a basic flocculating salt. Thus, when the basic flocculating salt is added to deionised water it forms a solution with a pH greater than 7, greater than 7.5, preferably greater than 8. Suitably the pH of when the basic flocculating salt is added to deionised water it forms a solution with a pH from 8 to 10.

The basic material may be a basic solution or solid. For example, it may be a substance which increases the number of hydroxide ions in an aqueous solution when added to an aqueous solution.

As is the case with the first aspect, the 2D material may be made “in-situ” in the processes of the second aspect. This is achieved by exfoliating a bulk multi-layered material (e.g. boron nitride or a TMDC) in the solvent. The layered material required to produce the analogous 2D material will be known to those skilled in the art. Suitable bulk layered materials include but are not limited to boron nitride, molybdenum disulphide, molybdenum diselenide, tungsten disulphide etc.

The exfoliation may be performed in the presence of one or both of the particulate material and the basic material

Thus, in an embodiment, the process of the second aspect comprises:
a) providing a dispersion of a bulk layered material in a solvent;
b) adding a particulate material to the dispersion;
c) exfoliating the layered material, before or after the addition of the particulate material, to form a 2D material in the dispersion;
   wherein the process comprises introducing basic material into the dispersion prior to or following any one of steps a) to c); wherein the presence of the flocculating agent in the dispersion causes an interaction between the particulate material and 2D material to form a composite. The basic material may be added prior to addition of the 2D material or after addition of the 2D material. The basic material may be added prior to exfoliation or added after exfoliation. Similarly, the basic material may be added prior to addition of the particulate material or after addition of the particulate material.

The 2D material may be pre-prepared and added directly to the solvent without the need for exfoliation. Thus, in another embodiment, the process of the second aspect comprises:

a) providing a dispersion of a 2D material in a solvent;

b) adding a particulate material to the dispersion;

wherein the process comprises providing a basic material in the dispersion prior to or following any one of steps a) or b); wherein the presence of the basic material in the solvent results in the interaction between the particulate material and 2D material to form a composite. Surprisingly, this process is found to form a composite between the two materials despite the prior stabilisation of the 2D material in the ready-made dispersion.

The basic material may be provided as part of a ready-made dispersion of 2D material. Thus, in another embodiment, the process of the second aspect comprises:

a) providing a dispersion of a 2D material and a basic material in a solvent;

b) adding a particulate material to the dispersion;

wherein the presence of the basic material in the solvent causes an interaction between the particulate material and 2D material to form a composite. Surprisingly, this process is found to form a composite between the two materials despite the prior stabilisation of the 2D material in the ready-made dispersion.

The basic material may be present in the solvent before the 2D material (or bulk material) is added.

### 3. Exfoliation Prior to Composite Formation

As discussed above, in some embodiments of the methods described herein, the 2D material is provided by exfoliation of the corresponding bulk layered material in the solvent. This allows both the exfoliation and generation of a composite in a “one pot” process. For example, if graphene is to be provided in the solvent, then exfoliation of graphite may take place within the solvent. The exfoliation may suitably comprise the step of removing unexfoliated bulk material (e.g. by centrifugation). Once the 2D material has been prepared, composite formation takes place.

An advantage of the present invention is its flexibility, for example it allows for a 2D material to be generated in-situ by homogenising a dispersion of bulk layered material (e.g. in the first aspect graphite-based materials, boron nitride etc and in the second aspect non-graphite-based materials).

In some embodiments, the 2D material is provided by exfoliation of the corresponding bulk layered material in the solvent. For example, if graphene is to be provided in the solvent, then exfoliation of graphite may take place within the solvent. The exfoliation may suitably comprise the step of removing unexfoliated bulk material.

If the method of the first or second aspect comprises exfoliation of the bulk material to form a 2D material prior to composite formation, the exfoliation may be carried out prior to addition of the particulate material to the solvent or following addition of the particulate material to the solvent.

If the method of the first aspect comprises exfoliation of the bulk material to form a 2D material prior to composite formation, the exfoliation may be carried out prior to providing the non-basic flocculating salt in the solvent or in the presence of the non-basic flocculating salt. Exfoliating in the presence of a non-basic salt may be advantageous in certain embodiments, as the non-basic salt may provide the dual functionality of both increasing the exfoliation yield and also functioning as a flocculating salt.

If the method of the second aspect comprises exfoliation of the bulk material to form a 2D material prior to composite formation, the exfoliation may be carried out prior to providing the flocculating agent (e.g. the flocculating salt) in the solvent or in the presence of the flocculating agent (e.g. the flocculating salt). Exfoliating in the presence of a flocculating agent may be advantageous in certain embodiments, as the flocculating agent may provide the dual functionality of both increasing the exfoliation yield and also functioning as a flocculating salt.

The exfoliation may comprise subjecting the layered material to energy. Suitably, the exfoliation comprises sonication, shear mixing, or high-pressure homogenisation, preferably at a shear rate of at least 10⁴ s⁻¹. Suitable methods of exfoliation will be familiar to the skilled person in the art. Suitably, the exfoliation may comprise exfoliation in the presence of salts that do not induce flocculation (i.e. are non-flocculating).

Suitably, the exfoliation does not comprise the use of acids. Aggressive treatment with oxidising acids can involve expansion of the layers in the layered material and introduce oxidation beyond 15 atom %.

Suitably, the exfoliation does not comprise the use of manganese, nitrates or peroxides. Such materials can have detrimental effects on the electronic properties of graphene-based materials.

Suitably, if it is graphite to be exfoliated (in the process of the first aspect), the exfoliation does not introduce oxidation beyond 15 atom % or beyond 10 atom %.

The bulk layered material may be graphite, partially oxidised graphite, boron nitride or the analogous bulk material of any of the 2D materials disclosed herein.

The exfoliation of the bulk layered material may be performed in the presence of a flocculating salt which also acts as an exfoliant or enhances exfoliation. Non-basic salts which can be used to enhance exfoliation include LiCl, Li2SO4, NaCl, Na2SO4, K2SO4, copper chloride, iron (II) chloride, iron (III) chloride, potassium carbonate, potassium persulfate, tripotassium phosphate, acetic acid and ammonium thiocyanate. Basic materials which can be used to enhance exfoliation include NaOH, KOH, LiOH, ammonium carbonate, ammonium sulfide, sodium citrate, potassium citrate and lithium citrate. Such salts may serve as flocculating salts without further treatment, while other salts may require further treatment to serve as effective flocculating salts. Such treatments to render the salt substantially insoluble in the solvent include but are not limited to treatment with an antisolvent, addition of a further salt or supersaturation.

The bulk layered material may be in the form of flakes, e.g. graphite or boron nitride flakes, prior to exfoliation. The flakes may have a particle size of 1 micron to 5000 microns—a large range of graphite flake sizes are known to function as sources of graphene sheets in the art. Preferably, such flakes will have smaller size (10 micron to 1000 microns), more preferably 100 microns to 500 microns. Without wishing to be bound, it is believed that using a source of smaller flakes (e.g. graphite flakes) increases the yield of 2D material (e.g. graphene flakes).

The 2D material will typically be present in the composite in the form of flakes (also termed nanosheets or platelets). The flakes of 2D material in the formed composite will typically have a size of 0.6 microns to 16 microns, preferably 1 to 10 microns, more preferably 1.5 to 5 microns. Suitably, the flakes will typically have a size of 0.1 microns to 16 microns, preferably 0.1 to 10 microns, more preferably 0.5 to 5 microns.

The 2D material will typically have a thickness of from 1 to 10 layers (i.e. atomic or molecular layers). Suitably, the thickness is from 1 to 5, 1 to 3 or 1 to 2 layers.

Suitably, at least 50%, 70%, 90% or 95% by weight of the 2D material will have a thickness of 1 to 10 layers. Suitably, at least 50%, 70%, 90% or 95% by weight of the 2D material will have a thickness of 1 to 5 layers. Suitably, at least 50%, 70%, 90% or 95% by weight of the 2D material will have a thickness of 1 to 2 layers.

### 4. General Processes of the Invention

It will be appreciated that the order of the steps in the processes described herein may be varied in any workable manner by the skilled person. Thus, the processes described herein are not intended to be limited by the order in which the steps are recited.

It will be appreciated that combinations of 2D materials may be utilised in the processes of the invention, resulting in composites comprising a plurality of 2D materials.

The 2D material may be added directly to the solvent, be provided pre-prepared in the solvent or be prepared in the solvent by exfoliation of the corresponding bulk layered material. The 2D material may be exfoliated in or added directly to a solvent comprising a flocculating agent (e.g. an aqueous solution of sodium hydroxide).

When the 2D material is prepared by exfoliation within the solvent, the exfoliation may be performed before addition of the particulate material and/or the flocculating salt to the solvent.

Typically, the composite will be dried following formation, to ensure removal of excess solvent. The drying may comprise one or more of freeze drying, spray-drying, spray-freeze drying, supercritical drying, vacuum-assisted drying at ambient temperature, vacuum-assisted drying at temperatures between 300 and 1500 degrees Celsius, vacuum-assisted drying at temperatures between 100 and 350 degrees Celsius, heating in an drying oven, heating in a drying oven under inert gas such as nitrogen or argon.

The interaction between 2D material and particulate material may result in the attachment of said materials to one another, via electrostatic or ionic interactions. This interaction may result in an increase in the particle size of the formed composite, relative to the particulate material. The composites described herein may have an increased particle size relative to the initial size of the particulate material. The particle size of the composite may be 10 to 2000 times larger, 50 to 1500 times larger or suitably 100 to 1000 times larger than the initial size of the particulate material. Such increase in particle size may be observable under a microscope. Indeed, a significant benefit of the present invention is the production of homogeneous composite materials that are of greater size than their precursors. In some embodiments, it may be that the formed particle size is large enough to remove the formed product via methods not normally utilised in the production of nanomaterials; e.g. coarse filtration, gravity separation.

The interaction between 2D material and particulate material may result in the destabilisation of a previously stabilised dispersion. Therefore, in some embodiments, the formation of the composite may be indicated by the formation of a precipitate.

The particle size of the composite formed may be greater than or equal to 10 microns, 50 microns or suitably greater than or equal to 100 microns. The particle size of the composite formed may be 10 to 1000 microns, 50 to 500 microns or suitably 100 to 250 microns. 50-250 microns is preferred as this is thought to be easily achievable by a wide range of flocculating salts. Preferably, the formed sizes are smaller than 5000 microns, as creation of very large particles may make processing more difficult, and would likely require large amounts of flocculating salt.

The processes of the invention may also comprise removing and/or recovering the flocculating salts present in the solvent. Salts are useful flocculating agents as they have well-understood solubilities and dissolving behaviour. Additionally, the elements present in the flocculating salts can be carefully chosen to be different to the elements present in the other particulate/2d materials. This means that removing/recovering of the flocculating salts can be easily validated or quantified by techniques known in the art such as XPS, TOF-SIMS, or ICP-OES.

A great advantage of the present process is that the composite may be recovered and the solvent recovered and re-used. Thus, the process may further comprise recovering the composite, and optionally recovering the solvent, preferably for re-use. Advantageously, the recovery of the composite in some embodiments is believed to be possible due to the cohesive composite structure formed upon interaction between the 2D material and the particulate material. For example, the interaction between the 2D material and the particulate material contributes to the components remaining interspersed in the composite, reducing the likelihood of separation of the individual components.

These properties of the products made by the present process facilitate the use of more expensive or higher boiling-point solvents that would normally be not economically feasible. These solvents normally have far better dispersing properties—e.g. NMP compared to IPA.

Other components may be added to the solvent. For example, the process may further comprise providing a surfactant in the first dispersion fluid. The process may comprise adding additional stabilizers to retain the 2D material and/or the particulate material in a dispersion. In the case of metal oxides it is generally preferred to avoid the use of surfactants. The absence of a surfactant improves the interactions between the 2D material and particulate material. Surfactants can also interfere with the beneficial electrical properties of 2D materials such as graphene, thus reducing the usefulness of the final composite. Advantageously, the present invention facilitates the use of stabilisers or surfactants when necessary, while still providing the ability to form a composite on demand via the presence of a flocculating salt.

Preferably, the processes of the present invention are performed in the absence of a surfactant. Thus, the solvent in which the 2D and particulate materials are dispersed and the final composite may not comprise a surfactant. The solvent and/or the final composite may be substantially free of a surfactant. For example, the surfactant is present in the solvent in an amount of less than 0.1% by weight or less than 0.01% by weight. The surfactant is suitably present in the final composite in an amount of less than 10% by weight, less than 1% by weight or most preferably less than 0.1% by weight). The solvent and/or the final composite may be entirely free of a surfactant.

Some polymers provided as an emulsion or as dry powder may comprise a small amount of surfactant to stabilise them. In these cases, it may be that no additional surfactant is added during the course of the process.

As is known in the art, surfactants are compounds that lower the surface tension (or interfacial tension) between two liquids, between a gas and a liquid, or between a liquid and a solid. Surfactants may act as detergents, wetting agents, emulsifiers, foaming agents, and dispersants. In the context of the present invention, surfactants are considered to be organic compounds that are amphiphilic, meaning they contain both hydrophobic groups (their tails) and hydrophilic groups (their heads). Therefore, a surfactant contains both a water-insoluble (or oil-soluble) component and a water-soluble component.

As discussed herein, the process of the present invention does not require the use of surfactants. The avoidance of the use of surfactants means that no long washing steps are needed to separate the surfactant from the 2D material. Such steps are uneconomical and can result in separation of 2D material from the composite and/or agglomeration of the 2D material.

Although the presence of surfactants may have certain disadvantages, in some situations a surfactant may be unavoidable. The use of a flocculating agent can mitigate the potential issues associated with the removal of surfactants. For example, the processes of the invention can result in the formation of a composite has excellent interaction between the 2D material and the particulate material. This improved interaction results in a composite that can withstand the removal of surfactants without separating the 2D material from the composite or causing the 2D material to agglomerate.

Advantageously, the use of a flocculating agent can facilitate washing of the surfactant without causing separation of a composite material. This may be improved further by providing a flocculating salt is substantially insoluble in the washing media. Thus, in an embodiment, the surfactant may be removed by washing with a washing media. Suitably, the flocculating salt is substantially insoluble in the washing media.

In the processes of the present invention, the ratio of 2D material to particulate material in the solvent is 1:10000 by atom to 100:1 by atom. More preferably, the ratio is 1:1000 by atom to 10:1 by atom. Even more preferably, the ratio is 1:100 by atom to 5:1 by atom.

The flocculating salt(s) may be added in an amount of 1:10000 by atom to 100:1 by atom (relative to either the 2D material and/or the particulate material). More preferably, the ratio is 1:1000 by atom to 10:1 by atom. Even more preferably, the ratio is 1:100 by atom to 5:1 by atom.

Generally, the process may be conducted at around room temperature. The processes of the present invention may be conducted at a temperature in the range 0° C. to 260° C., preferably 0° C. to 110° C., more preferably 0° C. to 50° C.

### 5. Flocculating Agents

The term “flocculating agent ” (or interaction agent) is intended to encompass a material which induces flocculation of 2D materials and particulate materials, more specifically flocculation between a 2D material and a particulate material. Without wishing to be bound by theory, it is thought that components of a composite (2D materials and particulate materials) are attracted to highly charged solids, such as the presence of a precipitated ionic salt. Components of a composite may also be attracted to each other if the ionic strength of the solution is high enough to screen the naturally occurring surface charge that normally repulses particles that are dispersed in a solution—preferably, the ionic strength of a flocculating solution is above 0.1 M. Thus, other salts may be present in the solvent that do not induce flocculation. The flocculating agent may be insoluble in the solvents of the invention.

The flocculating salt(s) may be provided in the solvent by addition as a solid, or as a solution or as a gas.

Where basic or non-basic flocculating salts are utilised, multiple flocculating salts may be added throughout the course of the processes described herein.

One or more basic or non-basic flocculating agents may be added to the solvent as a solid, a liquid solution, or a gas. Addition may be performed before and/or after of a mixing or exfoliation step, before and/or after of the composite formation process and before and/or after providing a first flocculation to the solvent.

The flocculating salt may be generated by separately adding an acid and a base to a solvent. The flocculating salt which is formed as a result may be non-basic or basic. An example of the formation of a non-basic salt is the addition of hydrochloric acid and ammonia to a solvent, to form ammonium chloride. The flocculating salt may precipitate out of the solvent on formation. A flocculating salt may also be formed by adding two or more soluble neutral salts to a solvent and forming two or more soluble and/or insoluble salts, one or both of which may be a flocculating salt. A flocculating salt may also be formed by adding a one or more acidic or basic salts and one or more neutral salts to a solvent, thereby forming two or more soluble and/or insoluble salts, one or both of which may be a flocculating salt.

In some embodiments, the flocculating salt is generated in the solvent by transforming a (preferably soluble) source of salt (e.g. an acid and a base) into a flocculating salt by any one or more of: heat, pressure, reaction with non-salts (e.g. a gas in an atmosphere), catalysis, enzymes or light. ‘Precursor salts’ may be defined as sources of flocculating salts. Another example is the injection of gas in subcritical or supercritical conditions, which may induce supersaturation (and therefore insolubility) of previously solubilised salts.

Particular flocculating salts of interest are MOFs (metal organic frameworks), which are generated by reaction between a metal salt and one or more coordinating organic ligands. Ligands may be selected which are monovalent, divalent, trivalent, tetravalent, or more. Preferred MOFs are classified by ligands that act as linkers, in that they can coordinate to more than one metallic ion. This results in the formation of large structures that flocculate the composite more readily than dissolved ions. MOFs are also known by a person skilled in the art to be useful materials, with a very wide range of properties owing to the vast choice of metallic ions and organic ligands as subcomponents.

Suitably MOFs may be used as flocculating salts. Preferred MOFs used as flocculating salts are one or more selected from the list of: ZIF-8, ZIF-67, HKUST-1 (MOF-199), MOF-5, MOF-74, MOF-177, MOF-210, Ni—CPO-27, UiO-66, Cr-MIL-100, Cr-MIL-10, MIL-125, CAU-1-[Al4(OH)2(OCH3)4(H2N-bdc)3].xH2O, IRMOF-0. Bridging molecules like diaminobutane may be used (as is known to those skilled in the art) to enhance the rate of flocculation of the produced MOFs. This is preferred as higher rates or degrees of flocculation will lead to faster collection of product from large volumes of solvent.

The flocculating salts described herein may also be generated in the solvent by;

adding one or more precursor salts to a first solvent,

adding an antisolvent to the first solvent, wherein addition of the antisolvent causes the salt(s) to lose solubility and form the flocculating salt in the resulting solvent mixture. The antisolvent or the first solvent may both comprise solvent used in the mixture of 2D material and particulate material, or the solvent used to introduce the salt(s).

The flocculating salts described herein may also be generated in the solvent by;

adding two or more precursor salts to the solvent,

adding an antisolvent to the solvent, wherein addition of the antisolvent causes the precursor salts to react and form the flocculating salt in the solvent.

### Alkali Metal and Alkaline Earth Metal Flocculating Salts

Alkali metal phosphates may take the form:

M^{a}_{z}H_{3-z}PO₄(H₂O)_{y}, where 0 [symbol] z [symbol] 3 and 0 [symbol] y [symbol] 12; or

M^{a}_{z}H_{4-z}P₂O₇(H₂O)_{y}, where 0 [symbol] z [symbol] 4 and 0 [symbol] y [symbol] 16; or

M^{a}_{z}H_{(n+2-2x)-z}PₙO₃ₙ₊₁₋ₓ(H₂O)_{y}

wherein n is the number of phosphorus atoms; where x is the number of fundamental cycles in the molecule's structure, between 0 and (n+2)/2; where Ma is one or more of Li, Na, K, Rb, Cs, Fr; where Z is greater than 0 but is not greater than (n+2−2x); where 0 [symbol] y [symbol] 3(3n+1−x).

Alkaline earth metal phosphates may take the form:

M^{b}_{z}H_{(n+2-2x)-z}PₙO₃ₙ₊₁₋ₓ(H₂O)_{y},

wherein n is the number of phosphorus atoms; where x is the number of fundamental cycles in the molecule's structure, between 0 and (n+2)/2; where M^{b} is one or more of Be, Mg, Ca, Sr, Ba, Ra; where Z is greater than 0 but is not greater than 0.5(n+2−2x); where 0 [symbol] y [symbol] 3(3n+1−x). Suitably, the alkaline earth metal phosphate may be CaHPO₄.2H₂O or MgHPO₄.3H₂O.

Alkali metal sulphates may take the form:

M^{a}₂SO₄.nH₂O

wherein 0 [symbol] n [symbol] 12 and M^{a} is selected from one or more of Li, Na, K, Rb, Cs, Fr.

Alkaline earth metal sulphates may take the form:

M^{b}SO₄.nH₂O

wherein 0 [symbol] n [symbol] 12 and M^{b} is selected from one or more of Be, Mg, Ca, Sr, Ba, Ra.

Alkali metal nitrates may take the form:

M^{a}₂NO₃.nH₂O

wherein 0 [symbol] n [symbol] 6 and M^{a} is selected from one or more of Li, Na, K, Rb, Cs, Fr.

Alkaline earth metal nitrates generally take the form:

M^{b}NO₃.nH₂O

wherein 0 [symbol] n [symbol] 6 and M^{b} is selected from one or more of Be, Mg, Ca, Sr, Ba, Ra.

Alkali metal halides generally take the form:

M^{a}X.nH₂O

wherein M^{a} is selected from one or more of Li, Na, K, Rb, Cs, Fr; where X is selected from one or more of F, Cl, Br, I, At; wherein 0 [symbol] n [symbol] 6. Suitably, X is selected from F, Cl or Br.

Alkaline earth metal halides generally take the form:

M^{b}X₂.nH₂O

wherein M^{b} is selected from one or more of Be, Mg, Ca, Sr, Ba, Ra; where X is selected from one or more of F, Cl, Br, I, At; where 0 [symbol] n [symbol] 6. Suitably, X is selected from F, Cl or Br.

Suitably, in the formulas above, M^{a} is selected from one or more of Li, Na or K. suitably, in the formulas above, M_{b} is selected from Be, Mg, Ca, Sr or Ba. Suitably, M^{b} is selected from Ca or Mg.

Variations and mixtures of the above structures will be known to those skilled in the art.

### 6. Solvents and Dispersion Steps

The one or more solvents used in the processes described herein may be suitable for the effective dispersion of the particulate material and the 2D material. The solvent may be used to effectively mix the particulate material and the 2D material, i.e. the solvent may be thought of as a mixing media or a dispersion fluid. The solvent may be comprised of one or more organic solvents and water.

A number of solvents may be suitable for the process. The solvent used to disperse the 2D material may be the same or different from the solvent used to disperse the particulate material. The solvent may be selected from one or more of DMSO, acetone, water, THF, Chloroform, NMP, DMF, DMA, GBL, DMEU, Dihydrolevoglucosenone, Benzyl Benzoate, NVP, N12P, n-propanol, isopropanol, and/or N8P.

Suitably, the solvent is selected from one or more of Cyrene; DMSO; NMP; butyl lactate; dimethyl isosorbide; triacetin; DMF; 1,2-dichlorobenzene; benzonitrile; pyridine; triethyl citrate; THF, cyclohexanone; cyclopentanone; olefins including pentane, hexane, cyclohexane, heptane, cyclooctane; ethyl acetate; ethyl lactate; furfual; eugenol; isoeugenol; levulinic acid; chloroform; 1,2-dischloromethane; toluene; methyl-t-butyl ether; methyl ethyl ketone; trichloroethylene; xylene; IPA; Water; Acetone; Methanol Suitably, the solvent is selected from solvents or mixtures of solvents that have preferential dispersion characteristics for the 2D material, while having reduced/negligible dispersion characteristics for the particulate material. This can increase the speed at which flocculation/product collection occurs, as the total interaction strength between the solvent and the formed composite is less than if the solvent disperses both components of the composite well initially. Advantageously, in many embodiments, there is little limitation on solvents to be used, as typical constraints (e.g. boiling point, expense, temperature stability) are of less concern when the solvent can be easily collected from the flocculated composite material.

Suitably, the solvent is selected from hexane, pentane, chloroform, oils, or other substantially non-polar solvents. A second solvent may be added to provide a separate liquid phase, where the particulate and/or the 2D material can migrate to the interface between the two phases, especially when the two-phase system constitutes a Pickering emulsion which is stabilised by the particulate material. Such a two-phase system would disperse both particulate and 2D materials better than at least one of the components alone. Suitably, individual solvents for such a two-phase system have polarities which are substantially different from the 2D and/or particulate material, such that one or more of the materials are preferentially positioned at the interface of the solvents. Such solvents for emulsions or biphasic systems generally have opposing or otherwise differing polarities or surface tension, but must be substantially insoluble in each other, whether through their inherent miscibility or through the addition of dissolved material in one phase which is incompatible with the second phase. Solvents for this case suitably may be selected from the list of:

Water, dichloromethane, chloroform, pentane, hexane, IPA, methanol, toluene, ethyl acetate, trichloroethylene, xylene, acetone, and combinations thereof.

Suitably, the 2D material is dispersed in the solvent. Alternatively, the 2D material may be dissolved or partially dissolved in the solvent. Preferably, the 2D material is dispersed in the solvent. The 2D material may be present as a stabilised dispersion in the solvent.

Suitably, the 2D material is substantially insoluble in the solvent. Suitably, the flocculating agent (e.g. the flocculating salt that is non-basic or basic) is substantially insoluble in the solvent. Suitably, the particulate material is substantially insoluble in the solvent. Most suitably, the 2D material, particulate material and the flocculating agent are substantially insoluble in the solvent. It is thought that this improves the formation and collection of the formed composite from the solvent.

Suitably, flocculating agents disclosed herein (e.g. the basic and non-basic flocculating salts described herein) may be, soluble, insoluble or substantially insoluble in the solvent at the operating temperatures of the process. More suitably, the flocculating agents disclosed herein are insoluble or substantially insoluble in the solvent at the operating temperatures of the process.

The particulate material and the 2D material may be mixed together prior to addition of the non-basic or flocculating salt or basic material to form a dispersion. Suitably, the mixing comprises one or more of sonication, high shear homogenisation, blending, high pressure homogenisation, mixing, or by capture from a gaseous phase by a liquid. Suitably, the mixing comprises high speed homogenisation with a high shear mixer.

In some embodiments of the methods described herein, multiple flocculating salts may be added throughout the course of the process. For example, a MOF (Metal Organic Framework) is a solid that can be formed from multiple salts that are individually dissolved in the solvent, (SEE EXAMPLE 7). Alternatively, HCl solution and NH3 solution may be combined to form ammonium carbonate, which in most solvents is insoluble (SEE EXAMPLE 6). Adding different components at different times is beneficial for the homogeneous formation of a composite. For example, adding a small amount of flocculating or non-flocculating salts may cause a very slow interaction of the components, with the aim of producing initial ‘secondary particles’ which remain substantially suspended in solution. These suspended particles can then be brought out of the solvent rapidly with the addition of more flocculating salts. Forming small ‘secondary particles’ slowly ensures that the reactants have good time to mix in larger vessels, while the addition of more flocculating salts ensures rapid collection of the product out of a large volume of solvent.

The mixing may be performed for a certain amount of time to ensure a good dispersion is formed. Depending on the method of mixing, different mixing times are preferred. For example, when a high-shear rotor-stator homogeniser is used, mixing times between 5 seconds and 5 hours are preferred, more preferably 2 minutes to 2 hours, even more preferably 5 minutes to 100 minutes, most preferably 10 minutes to 55 minutes. When a continuous/batch stirring reactor is used, longer mixing times are preferred to ensure homogeneous mixture of the components, so mixing times between 1 minute and 5 hours are preferred, more preferably 5 minutes to 5 hours, even more preferably 20 minutes to 50 minutes. When certain models of high-pressure homogeniser are used, the mixing period is defined as the time that components are forced with a piston through a small gap or series of gaps. In this case, the number of passes can be between 1 and 10,000, preferably 1-1000, even more preferably 1-100, most preferably 3-50. When sonication is used, mixing times between 10 seconds and 72 hours are preferred, more preferably 1 minute to 10 hours, even more preferably 1 minute to 10 minutes.

Alternatively, the non-basic flocculating salt is added prior to the addition of the particulate material.

In the context of the present invention, a “dispersion” is intended to mean particles suspended in a fluid, such that over a long period (e.g. the mixing period, e.g. 2 hours), there is not substantial sedimentation of the particles. In certain embodiments, a ‘dispersion’ may refer to particles which are stabilised from permanent re-aggregation in a solvent. In other embodiments, a dispersion may refer to particles which are stabilised from re-aggregation in a solvent by one or more surfactants. Permanent re-aggregation may be defined as the formation of aggregates which take a significant amount of energy to re-disperse, that is, the aggregates will not be able to break apart during ordinary mixing processes.

It is advantageous if the process further comprises homogenising the mixture of the 2D material and particulate material, preferably with a high shear mixer to improve still further the interaction between them. This increases the degree of mixing of 2D material and the particulate material, thus increasing the homogeneity of the formed composite.

Thus, the process may further comprise homogenising bulk layered material or the 2D material in the solvent, and/or it may further comprise homogenising a separate dispersion of the particulate material prior to addition to the solvent. Such mixing may be performed with a high shear mixer or by sonication.

Generally, the process may comprise forming a mixture of 2D material and the particulate material in an amount of 0.01 to 10000 parts by weight particulate material to 1 part by 2D material. More suitably, the 2D material and the particulate material may be mixed in a ratio of 0.1 to 1000 parts by weight particulate material to 1 part by weight 2D material. Preferably, the 2D material and particulate material may be mixed in a ratio of 3 to 500 parts by weight particulate material to 1 part by weight 2D material. Most preferably, the 2D material and particulate material may be mixed in a ratio of 3 to 200 parts particulate material to 1 part by weight 2D material.

Generally, the process may further comprise forming a mixture of bulk layered material and the particulate material in an amount of 0.01 to 10000 parts by weight particulate material to 1 part by bulk layered material. More suitably, the bulk layered material and the particulate material may be mixed in a ratio of 0.1 to 1000 parts by weight particulate material to 1 part by weight 2D material. Preferably, the bulk layered material and particulate material may be mixed in a ratio of 3 to 500 parts by weight particulate material to 1 part by weight bulk layered material.

In another embodiment, the process may comprise mixing 2D material and the particulate material to form a composite comprising 0.001 to 5 wt. % 2D material and 95 to 99.999 wt. % particulate material.

In polymer composites, a range of 0.05 to 20 wt. % 2D material may be preferred. In metal oxide or polymer composites used as a dielectric, a 0.05 to 5 wt. % 2D material may be preferable.

Suitably, for metal oxides used in applications needing a high surface area, a range of 5 to 50 wt. % 2D material may be preferred. Other optimal % loadings may be used to balance the properties of the metal oxide (e.g. electrochemical activity) with those of the 2D material (e.g. conductivity).

7. Particulate Materials

The particulate material may be an organic material, for example a polymer. Suitable polymers include but are not limited to one or more of chitosan, polyurethane, aramid (meta- or para-), polycarbonate, polystyrene, PEDOT:PSS, PMMA, nylon (PET), PTFE, PVDF, polyaryletherketone, polypropylene carbonate, polyester, polystyrene, polylactic acid, polyurethane, poly(methyl methacrylate), polyvinyl alcohol, polyvinyl acetate and/or polyvinyl ester.

In one embodiment, the particulate material may comprise a polysaccharide, preferably chitosan. Chitosan is a polysaccharide polymer which can be dissolved in 1% acetic acid to form an easily processable solution. Without wishing to be bound by theory, it is believed that addition of base to a mixture of 2D material platelets and dissolved chitosan in a dispersion fluid simultaneously de-solubilises the polymer (forming small particles) and promotes the polymer's attachment to the 2D material. This forms an agglomerate composite material of 2D material and chitosan. There is demand for a process which can easily form graphene-polymer composites without the need for low-viscosity polymer precursors or functionalisation of graphene sheets. The present invention provides a method for forming such a composite between non-functionalised (i.e. pristine) graphene sheets (or partially oxidised graphene sheets) and polymer particles.

In another embodiment, the particulate material may be one or more of a polyurethane or poly(methyl methacrylate) (PMMA). PMMA and PU can be polymerised to form a surfactant-free emulsion of small particles in water. Addition of these emulsions to a dispersion of 2D material platelets, followed by the addition of a flocculating agent, produces a solid material which is believed to consist of 2D material sheets interdispersed within a loose matrix of polymer particles. This provides a potential alternative method to forming well-mixed 2D material-thermoplastic polymer composites without the use of solvent evaporation or functionalisation or polymerisation around/amongst the 2D material. This process also separates the polymerisation step from the 2D material incorporation step.

In some embodiments, the polymer is substantially insoluble in the solvent during the process. In other embodiments, the polymer is insoluble throughout the process. In some embodiments, the polymer is insoluble during and after the addition of the flocculating salt.

Alternatively, the particulate material comprises an inorganic material (especially semiconductor-type materials) for example, aluminium nitride, aluminium arsenide, silicon, silicon dioxide, silicon carbide, gallium nitride, gallium arsenide, gallium phosphide, indium nitride, indium phosphide, and/or indium arsenide.

Suitably, the particulate material comprises one or more metal (or metalloid) oxides (e.g. one or more of silicon dioxide, aluminium oxide, tin oxide, zinc oxide, iron oxide, zirconium oxide, tungsten trioxide, copper (ii) oxide, copper (i) oxide, cerium oxide, uranium oxide).

The metal oxides may be a photocatalytic metal oxide. Suitably, the photocatalytic metal oxide comprises titanium dioxide, preferably titanium dioxide comprising anatase and/or rutile, even more preferably titanium dioxide comprising a mixture of anatase and rutile. In this specification, “titanium dioxide”, “titania” and “titanium oxide” are generally used interchangeably unless the context suggests otherwise.

This is advantageous because the composite thereby has advantageous photocatalytic properties, including a half-life or other time constant for photocatalytic activity surprisingly shorter than anatase alone. Without wishing to be bound, it is currently thought that these improved photocatalytic properties result from the interaction between graphene sheets and titanium dioxide. In particular, the electrical conductivity of graphene sheets, intimately associated with titanium dioxide particles, is currently thought to reduce the probably of electron-hole recombination after titanium dioxide is excited by light of the appropriate wavelength resulting in a more efficient photocatalytic process.

The preferred metal oxides include period 3, 4, 5 and 6 metal oxides. Preferred metal oxides include aluminium oxide, silicon dioxide, barium titanate, iron oxide, nickel oxide, copper oxide, zirconium oxide, tin oxide and tungsten oxide. The metal oxide may be doped with another material (e.g. antimony-doped tin oxide, SbO/SnO).

The particulate materials may comprise pre-formed particulate materials, such as antimony-doped tin oxide. Graphene based composites of such materials have proven to be difficult to make using an in-situ process, but are desired for their conductivity.

The particulate materials may have a particle size of 5 nm-100000 nm, 5 nm-4000 nm, suitably 50 nm-1500 nm, more suitably 50 nm-600 nm. Smaller particle sizes are generally desired, as their higher surface area offers a more intimate contact with the 2D sheets. However, larger particle sizes may be easier to produce and stabilise, especially at large scales.

Suitably, the particulate material (in particular when the particulate material is titanium dioxide) has a particle size in the range 5 nm to 1 μm, preferably 10 nm to 500 nm, more preferably 15 nm to 250 nm.

Suitably, the particulate material is an inorganic compound. Suitably, the inorganic material is a metal oxide. The metal oxide may be any one or more of the metal oxides disclosed herein.

Suitably, the metal oxide is added to the solvent as a dispersion of particulates shielded from one another with capping agents which modify the surface of the particulates to prevent aggregation of the particles. Capping agents are often used in commercial formulations of suspended metal oxides, as they allow the transportation and easily handling of such metal oxides over time.

Suitably, the metal oxide is in the form of hydrated layers.

The particulate material may be a polymeric compound. The polymeric compound may be selected from chitosan, PMMA, polyurethane, thermoplastic polyurethane, rubber, PET, PCL), and copolymers thereof.

The particulate material may be added to the solvent in the form of a dispersion. Alternatively, the particulate material may be in the form of a solid.

The particulate material may have a particle size in the range 5 nm to 1 μm, preferably 10 nm to 500 nm, more preferably 15 nm to 250 nm.

### 8. Composites of the Invention

In another aspect, there is provided a composite obtained by, obtainable by or directly obtained by the processes defined herein.

The composite may be a photocatalytically active composite obtainable by the processes described herein.

In another aspect, there is provided a composite comprising a 2D material, a particulate material and a metal organic framework.

Suitably, the 2D material, particulate material and metal organic framework are mutually attached to one another in a flocculated product.

Suitably, the 2D material may be any of the 2D materials defined herein. Preferably, the 2D material is graphene.

Suitably, the particulate material may be any of the 2D materials defined herein. Preferably, the particulate material is a metal oxide.

Suitably, the metal organic framework may be any of the metal organic frameworks (MOFs) defined herein. The metal organic framework may be a zeolitic imidazolate framework

The presence of the metal organic framework can improve interaction between the 2D material and particulate material, while also offering interesting properties to the final composite.

In another aspect, there is provided a composite comprising a 2D material, a particulate material and a solid salt.

Suitably, the 2D material, particulate material and solid salt are attached to one another in a flocculated product.

Suitably, the 2D material may be any of the 2D materials defined herein. Preferably, the 2D material is graphene and the solid salt is one of the non-basic flocculating salts defined herein.

Suitably, the particulate material may be any of the 2D materials defined herein. Preferably, the particulate material is a metal oxide. The metal oxide may be any of the metal oxides defined herein.

Suitably, the solid salt in the composites of the invention may be any of the salts defined herein in the first or second aspect, as appropriate.

The presence of the solid salt can improve interaction between the 2D material and particulate material, while also offering beneficial properties to the final composite.

The particle size of the composite may be greater than or equal to 10 microns, 50 microns or suitably greater than or equal to 100 microns. The particle size of the composite formed may be from 10 to 1000 microns, 50 to 500 microns or suitably 100 to 250 microns.

The content of the solid salt in the composite may be 0.01-50% by weight, more preferably 0.01-10% by weight even more preferably 0.1-5% by weight, most preferably 1-5% by weight. In some embodiments, especially those including MOFs as flocculating salts, the content of the solid salt may preferably be higher than 10% by weight.

Composites obtainable by the process have many potential uses. Thus, composites (especially photocatalytically active composites) may be used in electrodes, e.g. as an anode material in a rechargeable cell (preferably lithium-ion); the use of composites obtainable by the above method as a graphene-semiconductor composite material; the use of photocatalytically active composites as an N-type semiconductor layer, which can be applied from fluid dispersion onto a surface. Such N-type semiconductor layers may be used in Perovskite solar cells, wherein composites produced by this method are used as the electron collection layer. Composites obtainable by the process may find use as a capacitive deionization electrode.

Photocatalytically active composites obtainable by the processes described herein have uses in many other areas, including removing aqueous and air-borne pollutants, in coverings, coatings and in paints.

Composites obtainable by the process may find use as a sorbent material to sorb (absorb and/or adsorb) gaseous or liquid pollutants from a flow of fluid for subsequent destruction or separation.

### BRIEF DESCRIPTION OF THE DRAWINGS

Embodiments of the invention are further described hereinafter with reference to the accompanying drawings, in which:

FIG. 1: Image of graphene dispersion from example 6

FIG. 2: Photograph of Graphene in DMSO dispersion and Titanium Oxide after 10 minutes sonication and 10 minutes rest. Little sedimentation or aggregation can be seen. (example 6)

FIG. 3: Image of Graphene, Titanium Oxide and the flocculant ZIF-8 in DMSO, immediately after mixing. (example 6)

FIG. 4: Image of Graphene, Titanium Oxide and the flocculant ZIF-8 in DMSO, 5 minutes after mixing. Some aggregation can be seen. (example 6)

FIG. 5: Image of a Graphene, Titanium Oxide and ZIF-8 flocculant in DMSO, 10 minutes after mixing. A great deal of flocculation/sedimentation can be seen (example 6)

FIG. 6: Image of Graphene, Titanium Oxide and the flocculant ZIF-8 in DMSO, 20 minutes after mixing.

FIG. 7: Image of the Graphene dispersion in Acetone:Water solvent. (example 7)

FIG. 8: Image of the Graphene in Acetone:Water Dispersion and Titanium Oxide, immediately after sonication for 10 minutes. (example 7)

FIG. 9: Image of the Graphene in Acetone:Water Dispersion and Titanium Oxide, after resting for 10 minutes. A white layer of settled TiO2 can be seen at the bottom of the beaker. (example 7)

FIG. 10: Image of Graphene in Acetone:Water, Titanium Oxide, 1M HCl (10 ml) and 1M Ammonia (10 ml) Immediately after mixing.(example 7)

FIG. 11: Image of the Graphene in Acetone:Water, Titanium Oxide, 1M HCl and 1M Ammonia 10 minutes after mixing, showing a grey flocculated product at the bottom of the beaker. (example 7)

FIG. 12: Raman spectrum of a nickel oxide-molybdenum disulfide composite produced via the process described in example 1 highlighting the E2g (peak centre calculated to be 381.47±0.83 cm\hat{ }−1 via custom peak fitting software) and A1g (peak centre calculated to be 407.14±0.45 cm\hat{ }−1 via custom peak fitting software) exfoliated molybdenum disulfide peaks (E2g peak centre to A1g peak centre distance calculated to be 25.67±1.28 cm\hat{ }−1 via custom peak fitting software). Spectrum was obtained using a Renishaw inVia Raman microscope with laser excitation wavelength=532 nm.

FIG. 13: Raman spectrum of a zinc oxide-graphene composite produced via the process described in example 2, highlighting the D, G and D′ graphene peaks. Spectrum was obtained using a Renishaw inVia Raman microscope with laser excitation wavelength=532 nm.

FIG. 14: Raman spectrum of a zinc oxide-graphene composite produced via the process described in example 2, highlighting the G, D′ and 2D graphene peaks. Spectrum was obtained using a Renishaw inVia Raman microscope with laser excitation wavelength=532 nm.

FIG. 15: Raman spectrum of a zirconium oxide-hexagonal boron nitride composite produced via the process described in example 3, highlighting the E2g exfoliated hexagonal boron nitride peak. Zirconium oxide peaks can be seen below 1,200 cm\hat{ }−1. Spectrum was obtained using a Renishaw inVia Raman microscope with laser excitation wavelength=532 nm.

FIG. 16: Raman spectrum of a zirconium oxide-hexagonal boron nitride composite produced via the process described in example 4, highlighting the E2g exfoliated hexagonal boron nitride peak. Spectrum was obtained using a Renishaw inVia Raman microscope with laser excitation wavelength=532 nm.

FIG. 17: Raman spectrum of a polyurethane-molybdenum diselenide composite produced via the process described in example 5 (with range from 0 to 1800 wavenumbers) highlighting the A1g exfoliated molybdenum diselenide peak. Spectrum was obtained using a Renishaw inVia Raman microscope with laser excitation wavelength=532 nm.

FIG. 18: Raman spectrum of a polyurethane-molybdenum diselenide composite produced via the process described in 5 (with range from 1550 to 3000 wavenumbers) highlighting the polyurethane peaks between 2750 cm\hat{ }−1 and 3000 cm\hat{ }−1. Spectrum was obtained using a Renishaw inVia Raman microscope with laser excitation wavelength=532 nm.

FIG. 19: Microscope image taken with a Swift SW350B microscope—the image is ˜560 microns across. This shows a mixture of PU nanoparticles and exfoliated MoS₂—no clear features can be discerned. The central diffuse spot is a defect in the microscope system.

FIG. 20: Microscope image taken with a Swift SW350B microscope—the image is ˜140 microns across This shows a mixture of PU nanoparticles and exfoliated MoS₂—with some small particles visible. The central diffuse spot is a defect in the microscope system.

FIG. 21: Microscope image taken with a Swift SW350B microscope—the image is ˜560 microns across. This shows the formation of large aggregates/flocs from the MoS2/PU mixture, after the addition of the flocculating agent ammonium carbonate.

FIG. 22: Microscope image taken with a Swift SW350B microscope—the image is ˜140 microns across. This is a close-up of the flocs shown in the previous figure.

FIG. 23: Microscope image taken with a Swift SW350B microscope—the image is ˜140 microns across. This shows the initial dispersion of MoSe2 and TiO2, with some small particles visible. The central diffuse spot is a defect in the microscope system. It is possible that some of the larger particles are due to the small amount of sodium citrate initially added as an exfoliation aid in this example, or due to incomplete exfoliation of the TiO2 particles during sonication.

FIG. 24: Microscope image taken with a Swift SW350B microscope—the image is ˜140 microns across. This shows a close-up of flocculations formed after addition of the flocculating salt (NaOH).

FIG. 25: UV/Vis Diffuse Reflectance Spectroscopy of a MoS2-TiO2 composite produced via the process described in example 10. A logarithmic scale is used on the vertical axis. Spectrum was obtained using a PerkinElmer Lamba 650S UV/Vis Spectrophotometer with a 60mm integrating sphere.

FIG. 26: UV/Vis Diffuse Reflectance Spectroscopy of a MoS2-PU composite produced via the process described in example 11. A logarithmic scale is used on the vertical axis. Spectrum was obtained using a PerkinElmer Lamba 650S UV/Vis Spectrophotometer with a 60 mm integrating sphere.

FIG. 27: UV/Vis Diffuse Reflectance Spectroscopy of a WSe2-Zno composite produced via the process described in example 12. Spectrum was obtained using a PerkinElmer Lamba 650S UV/Vis Spectrophotometer with a 60mm integrating sphere.

FIG. 28: UV/Vis Diffuse Reflectance Spectroscopy of a WSe2-PU composite produced via the process described in example 13. A logarithmic scale is used on the vertical axis. Spectrum was obtained using a PerkinElmer Lamba 650S UV/Vis Spectrophotometer with a 60 mm integrating sphere.

FIG. 29: UV/Vis Diffuse Reflectance Spectroscopy of a MoSe2-SnO composite produced via the process described in example 14. Spectrum was obtained using a PerkinElmer Lamba 650S UV/Vis Spectrophotometer with a 60mm integrating sphere.

FIG. 30: UV/Vis Diffuse Reflectance Spectroscopy of a MoSe2-PU composite produced via the process described in example 15. A logarithmic scale is used on the vertical axis. Spectrum was obtained using a PerkinElmer Lamba 650S UV/Vis Spectrophotometer with a 60mm integrating sphere.

FIG. 31: UV/Vis Diffuse Reflectance Spectroscopy of the empty reflectance test cell used to place composites inside to show a background. Spectrum was obtained using a PerkinElmer Lamba 650S UV/Vis Spectrophotometer with a 60mm integrating sphere.

FIG. 32: UV/Vis Diffuse Reflectance Spectroscopy of the empty reflectance test cell used to place composites inside to show a background. A logarithmic scale is used on the vertical axis. Spectrum was obtained using a PerkinElmer Lamba 650S UV/Vis Spectrophotometer with a 60mm integrating sphere.

FIG. 33 shows optical images of graphene/SnO suspension immediately after mixing (left) and after 5 min settling (centre). A white layer of SnO particles can be seen to form at the bottom of the dispersion after 5 minutes of settling. This white layer (even upon observation with reflectance optical microscopy) appears to show no graphene (which is black) entrapped within the particles.

FIG. 34 shows the same sample as shown in FIG. 33, but this time a flocculating salt (CaSO4) is added to the dispersion before 5 min settling. The top-left tile shows the mixture of components immediately after mixing. The top-right tile shows the mixture of components after 5 min settling. Instead of white ‘non-composited’ SnO (seen in FIG. 33), there is a dark grey solid composite of graphene and SnO. Optical reflectance microscopy (bottom) reveals the solid to be an intimate mixture of graphene particles and SnO particles.

FIG. 35: Microscopy of well-mixed SnO/EEG dispersion.

FIG. 36: Microscopy of SnO/EEG composite, formed via addition of calcium chloride and phosphoric acid.

FIG. 37 shows photographs of (left) graphene-ZrO2 mix, (middle) 2 wt % graphene-ZrO2 composite and (right) 4 wt % graphene-ZrO2 composite, with the post mixing images (left) and post settling images (right). Comparable amounts of settled black solid can be observed in the 2% IA and 4% IA ‘post settle’ images. However, very little solid is observed in the sample with no IA added.

FIG. 38 shows dispersion images (top) and resulting solid (bottom) of (left) graphene-ZnO2 mix, (middle) 2 wt % graphene-ZnO2 composite and (right) 4 wt % graphene-ZnO2 composite.

FIG. 39 shows microscope image showing large agglomerate of black graphene particles. ZnO is white, which makes a clear contrast between the black graphene and the white metal oxide particles.

FIG. 40 shows microscope image also showing large aggregates of graphene and metal oxide particles. This image was taken at the edge. The black line at the edge indicates that graphene material were freely independent of the zinc oxide, and were trapped in the receding solvent as it evaporated.

FIG. 41 shows microscope image showing close-up of graphene material agglomerate. It is clear that graphene is not well-mixed in the zinc oxide host material.

FIG. 42: In this optical reflectance microscopy image, graphene material is observed to be distributed homogeneously and in small aggregates throughout the composite. The presence of these smaller aggregates (as opposed to a totally homogeneous composite) is believed to be due to incomplete dispersion in the first graphene dispersion step.

FIG. 43: In this optical reflectance microscopy image, large aggregates of graphene material are observed. Little graphene can be seen outside of the agglomerates.

FIG. 44: In this optical reflectance microscopy image, a homogeneous solid mixture of graphene and ZnO is observed.

FIG. 45: In this zoomed in optical reflectance microscopy image, a homogeneous solid mixture of graphene and ZnO is observed. This is facilitated by the use of lithium phosphate as a flocculating salt. The large white blobs are from out-of-focus material. Large cracks can be seen amongst the material, it is believed that these are only seen in the composites with LiPO.

FIG. 46 shows samples with different molar ratios of calcium chloride and ammonium phosphate.

FIG. 47: In this zoomed in optical reflectance microscopy image, the solid material collected from the bottom of the control sample (CaPO=calcium phosphate) is seen to contain far more graphene (e.g. it is much darker) than the control material.

FIG. 48: These microscope images (each roughly 250 microns across) show the solids formed on the interdigitated electrode surfaces. The bright regions on the top/bottom (left image) and left/right (right image) are the gold contacts from the interdigitated electrode materials. The left image (no Li2SO4) appears to have isolated aggregates of graphene within the material. However, the right image (with Li2SO4) appears to have a more homogeneous mixture of graphene and SnO.

FIG. 49: This image shows the composite formed after BaSO4 addition (left) and the absence of any obvious composite formation in the control material produced without sulphuric acid which would normally complete the formation of BaSO4 (right).

FIG. 50: In this optical reflectance microscopy image, the ZrO2/graphene/HKUST-1 material is observed to be a homogeneous mixture. No large agglomerates of graphene can be seen.

FIG. 51: This camera photo is of a centrifuge tube after centrifugation of the first TiO2/graphene mixture made in example 28. A white precipitate (e.g. with little graphene incorporation) can be seen on the bottom of the centrifuge tube, while a layer of black material (graphene) rests on the top. The supernatant above the solid is seen to be slightly grey, this indicates that some graphene is also left behind in the dispersion.

FIG. 52: This low-magnification optical reflectance microscopy image shows poorly mixed graphene material and poorly mixed TiO2 in a film from example 29.

FIG. 53: This photograph shows the bottom of the CaPO (salt-flocculated) sample (left) and control (right) after ˜16 hours settling. Grey homogeneous solid can be seen at the bottom of the left sample, while a grey-white mixture can be seen at the bottom of the right sample.

FIG. 54: This optical reflectance microscopy image is indicative of the unwashed solids collected from the control sample in example 30. Some black particles (trapped graphene) can be seen, but the majority of the particles appear to be agglomerated PVDF (seen as large white particles).

FIG. 55: This optical reflectance microscopy image is indicative of the unwashed solids collected from the CaPO (salt-flocculated) sample in example 30.

FIG. 56: This optical reflectance microscopy image is indicative of the washed solids collected from the control sample in example 30. Aggregated PVDF particles with some small remnants of graphene material can be seen.

FIG. 57: This optical reflectance microscopy image is indicative of the washed solids collected from the CaPO (salt-flocculated) sample in example 30. A homogeneous mixture of PVDF material and graphene material can be seen. Much more graphene particles are observed in this material than in the washed control sample.

FIG. 58: This photograph shows the difference in the colour of the supernatant between the control (left centrifuge tube) and salt-flocculated (right centrifuge tube) samples after the first step of washing. Darker supernatant can be seen in the control sample due to separation of graphene material from the PVDF material. Meanwhile, the clear supernatant in the right centrifuge tube indicates that salt flocculation creates composites with high resistance to washing steps.

FIG. 59: These photographs show the mixture formed from sodium aluminate, HCl, WS2 and PS (example 20), immediately after the formation of a flocculating salt (left) and after 40 minutes settling (right).

FIG. 60: This optical microscopy image shows the flocculated particles formed after addition of the flocculating salt in Example 20. No particles could be observed by optical microscopy before addition of the flocculating salt.

FIG. 61: This SEM image shows the intimate mixture of PS particles (spheres) and WS2 (flakes) in Example 20.

FIG. 62: Raman spectrum of FLG (Goodfellow Cambridge Ltd) from example 26. Spectrum was obtained using a Renishaw inVia Raman microscope with laser excitation wavelength=532 nm.

FIG. 63: This photograph shows 10 ml of the ‘M3’ sample immediately after addition of the flocculating salts. Newly formed particles can be seen floating in suspension (example 16).

FIG. 64: This image shows an optical microscope image of ‘M3’ after flocculating salt is added.

FIG. 65: This photograph shows all three mixtures (M1, M2, M3) after settling for 16 hours. The small vial on the far-right image shows no formation of solid after the same settling period.

FIG. 66: This UV/Vis spectrum characterises the initial MoS2 dispersion prepared in the first step of example 16. It shows the A and B excitons of MoS2 exfoliated sheets.

FIG. 67: Raman spectrum of EEG (Sixonia Gmbh) from example 19. Spectrum was obtained using a Renishaw inVia Raman microscope with laser excitation wavelength=532 nm.

FIG. 68: SEM image of MOF-199/ZrO2/graphene from example 27. This image shows ZrO2 particles (5 microns across) and graphene encapsulated by MOF particles (small chunks).

### DETAILED DESCRIPTION

The term ‘two-dimensional material” (2D material) may mean a compound in a form which is so thin that it may exhibit different properties than the same compound when in bulk. Typically, two-dimensional inorganic compounds are in a form which is single- or few layers thick, i.e. up to 10 layers thick. A two-dimensional crystal of a layered material (e.g. an inorganic compound or graphene) is a single or few layered particles of that material.

2D materials do exhibit thicknesses, however the dimensions of those thicknesses are significantly lower than the widths and lengths of these materials, thus the origin of the name ‘2D materials’.

The term ‘few-layered particle’ means a particle which is so thin that may exhibit different properties than the same compound when in bulk. Not all of the properties of the compound will differ between a few-layered particle and a bulk compound, but one or more properties are likely to be different. A more convenient definition would be that the term ‘few layered’ refers to a crystal that is from 2 to 9 atomic or molecular layers thick in cross-section (e.g. 2 to 5 layers thick). Crystals of graphene, for example, which have more than 9 molecular layers (i.e. 10 atomic layers; 3.5 nm) generally exhibit properties more similar to graphite than to graphene. An atomic or molecular layer is the minimum thickness chemically possible for the compound. In the case of boron-nitride one molecular layer is a single atom thick. In the case of the transition metal dichalcogenides (e.g. MoS₂ and WS₂), a molecular layer is three atoms thick (one transition metal atom and two chalcogen atoms). Thus, few-layer crystals of 2D materials are generally less than 50 nm thick, depending on the compound and are preferably less than 20 nm thick, e.g. less than 10 or 5 nm thick.

The ‘inorganic compounds’ referred to throughout this specification are inorganic layered compounds. Thus, the term ‘inorganic compound’ refers to any compound made up of two or more elements which forms layered structures in which the bonding between atoms within the same layer is stronger than the bonding between atoms in different layers. Many examples of inorganic layered compounds have covalent bonds between the atoms within the layers but van der Waals bonding between the layers. The term ‘inorganic layered compound’ is not intended to encompass graphene.

Many inorganic compounds exist in a number of allotropic forms, some of which are layered and some of which are not. For example boron nitride can exist in a layered graphite-like structure or as a diamond-like structure in which the boron and nitrogen atoms are tetrahedral orientated.

Examples of layered inorganic compounds to which the present invention can be applied include: hexagonal boron nitride (hBN), bismuth strontium calcium copper oxide (BSCCO), transition metal dichalcogenides (TMDCs), Sb₂Te₃, Bi₂Te₃ and MnO₂.

TMDCs are structured such that each layer of the compound consists of three atomic planes: a layer of transition metal atoms (for example Mo, Ta, W . . . ) sandwiched between two layers of chalcogen atoms (for example S, Se or Te). Thus in one embodiment, the TM DC is a compound of one or more of Mo, Ta and W with one or more of S, Se and Te. There is strong covalent bonding between the atoms within each layer of the transition metal chalcogenide and predominantly weak Van der Waals bonding between adjacent layers. Exemplary TMDCs include NbSe₂, WS₂, MoS₂, TaS₂, PtTe₂, VTe₂.

A layer of graphene consists of a sheet of sp²-hybridized carbon atoms. Each carbon atom is covalently bonded to three neighbouring carbon atoms to form a ‘honeycomb’ network of tessellated hexagons. Carbon nanostructures which have more than 10 graphene layers (i.e. 10 atomic layers; 3.5 nm) generally exhibit properties more similar to graphite than to mono-layer graphene. Thus, throughout this specification, the term graphene is intended to mean a carbon nanostructure with up to 10 graphene layers. Graphene is the ‘ultimate’ 2D material as it is defined by having one carbon atom thickness layer/sheet, which is a structural unit of graphite.

The level of graphene defects in a composite can be assessed using Raman spectroscopy in a manner similar to L. G. Cancado et al. 2011, “Quantifying Defects in Graphene via Raman Spectroscopy at Different Excitation Energies”, Nano Letters, which is incorporated herein by reference. The ratio of the intensity of the observed D peak Raman intensity, referred to as I(D), to the G peak Raman intensity, referred to as 1(G), indicates the amount of defects present within the graphene. This is referred to as the I(D)/I(G) ratio. The distance between defects is a measure of the amount of disorder. Given the distance between defects is greater than approximately 4 nm; the lower the I(D)/I(G) ratio, the greater the distance between defects, thus, the amount of disorder is lower. In addition to this, the full width atof half maximum (FWHM) of D, G, 2D (also referred to asin some literature called G′), D′ peaks can be used to evaluate the level of disorder as discussed in E. H. Martins Ferreira et al. 2010, “Evolution of the Raman spectra from single-, few-, and many-layer graphene with increasing disorder”, PHYSICAL REVIEW B work. If FWHM of D, G, 2D (in some literature called also referred to as G′), and D′ Raman peaks at a laser excitation wavelength of 514.5 nm (2.41 eV), are reaching values lowerhigher than 20 cm-1, 20 cm-1, 35 cm-1, and 10 cm-1 respectively, then the distance between zero dimensional pointlike defects is expected to be greater than approximately 4 nm.

The composites formed by the method of the present invention may have an I(D)/I(G) ratio of less than 0.75, less than 0.6 or preferably less than 0.5 , at a laser excitation wavelength of 532 nm (2.33 eV). Thus, the composites formed by the method of the present invention may have an I(D)/I(G) ratio of from 0.01 to 0.75, 0.02 to 0.65 or 0.04 to 0.55, at a laser excitation wavelength of 532 nm (2.33 eV). Given the distance between defects is greater than approximately 4 nm and a laser excitation wavelength of 532 nm (2.33 eV); an I(D)/I(G) ratio less than 1 indicates that the defects are greater than 9.5 nm apart.

It is also possible to assess the nature of the graphene defects using Raman spectroscopy. In general, defects in graphene are considered to be anything that breaks the symmetry of the infinite carbon hexagonal lattice. This therefore includes edges, vacancies and changes in carbon-hybridization (e.g. sp² into sp³). An sp³ defect is due to an additional atom being present out-of-plane of the graphene layer resulting in an sp³ hybridized carbon atom or atoms. A vacancy defect is due to one or more missing atoms of a 2D material layer. An edge defect is due to a graphene sheet not being infinitely large and therefore having an edge.

Partially oxidised graphene and pristine graphene can be distinguished from graphene oxide, functionalised graphene and reduced graphene oxide using Raman spectroscopy, as discussed herein. Graphene oxide and functionalised graphene contain high amounts of sp³ defects. Reduced graphene oxide is formed from the reduction of graphene oxide with reducing agent or temperature treatment. Reduced graphene oxide also includes a large amount of vacancy defects, as a result of the removal of oxygen to leave holes in the hexagonal lattice. Thus, graphene oxide and reduced graphene oxide typically have an I(D)/I(G) ratio of above 0.8 or FWHM of D, G, 2D (in some literature called G′) peaks values higher than 70, 70, 150 cm⁻¹ respectively. Conversely, partially oxidised graphene oxide has fewer oxygen atoms compared to graphene oxide but has not undergone harsh reduction processes like reduced graphene oxide. Thus, more of the hexagonal structure is maintained, meaning fewer sp³ and vacancy defects. The number of defects can be assessed by measuring the I(D)/I(G) ratio or FWHM of peaks as discussed above.

The presence of sp³ defects and vacancy defects can have a detrimental impact on the usefulness of the final composite. Thus, it is desirable for the number of sp³ and/or vacancy defects to be minimised.

The ratio of the intensity of the Raman D peak, referred to as I(D), to the Raman D′ peak, referred to as I(D′), signifies the type of defects present in the sample. This is referred to as the I(D)/I(D′) ratio. A ratio less than approximately 3.5, at a laser excitation wavelength of 514.5 nm (2.41 eV) indicates contributions from edge defects dominate. A ratio of approximately 7 indicates the presence of vacancy defects and a ratio of approximately 13 or more suggests sp3 defects.

The graphene composites of the present invention may have a FWHM-(G) (Full Width at Half Maximum of the graphene Raman G peak of a raman spectra) of lower than 70 cm⁻¹ at a laser excitation wavelength of 514.5 nm (2.41 eV). Preferably, the FWHM-(G) will be lower than 60 cm⁻¹ at a laser excitation wavelength of 514.5 nm (2.41 eV). More preferably, the FWHM-G will be lower than 50 cm⁻¹ at a laser excitation wavelength of 514.5 nm (2.41 eV). Even more preferably, the FWHM-(G) will be lower than 40 cm⁻¹ at a laser excitation wavelength of 514.5 nm (2.41 eV). Most preferably, the FWHM-(G-) will be lower than 30 cm⁻¹ at a laser excitation wavelength of 514.5 nm (2.41 eV).

The graphene composites of the present invention may have a FWHM-(2D) (Full Width at Half Maximum of the graphene Raman 2D peak) of the present invention graphene composites may be lower than 100 cm⁻¹ at a laser excitation wavelength of 514.5 nm (2.41 eV). Preferably, the FWHM-(2D) will be lower than 80 cm⁻¹ at a laser excitation wavelength of 514.5 nm (2.41 eV). More preferably, the FWHM-(2D) will be lower than 60 cm⁻¹ at a laser excitation wavelength of 514.5 nm (2.41 eV). Even more preferably, the FWHM-(2D) will be lower than 50 cm⁻¹ at a laser excitation wavelength of 514.5 nm (2.41 eV). The graphene composites of the present invention may have an I(D)/I(D) ratio of from 0.01 to 7, 0.01 to 4.5, 0.01 to 3.5 or preferably from 0.1 to 3.45 at a laser excitation wavelength of 532 nm (2.33 eV). Thus, the composites of the present invention will preferably have minimal sp3 defects and more preferably minimal vacancy defects.

Graphene oxide typically comprises a weight percentage of oxygen of above 15 wt. %. In the scope of the present invention, the term “partially oxidised graphene” can be interpreted as a graphene oxide which only comprises oxygen in an amount of up to 15% of the total weight of the graphene, e.g. 5 to 15 wt. %. Typically, partially oxidised graphene would include oxygen in an amount of up to 10% of the total weight of the graphene. As discussed above, the term “pristine graphene” refers to graphene which has not been chemically modified.

The processes described within may be performed without the use of graphene that is substantially chemically modified. However, some graphene production methods may introduce some degree of oxidation (below 15%) as a result of slight oxidation facilitating faster exfoliation. However, unlike previous work involving graphene oxide, this degree of oxidation does not necessarily increase the processability of the graphene, and preferably the degree of oxidation/the degree of defects is reduced to as low as possible to reduce the impact on the conductive properties of the final composite material.

Flocculation is a widely used effect used in water purification, cheesemaking, brewing, and throughout other areas of chemistry to collect a product from a dispersion or fine suspension in a liquid fluid. It may involve one or more of a combination of steps:
Changing the pH of a dispersion, to such a value that the surface charge on the particulate components no longer repulses nearby particles,
Adjusting the temperature of a dispersion, to such a value that particles can overcome the particle-particle repulsion to stick together,
Adding an excess of any of the components, such that stabilisation is no longer possible,
Adding a non-solvent to the dispersion to reduce the stabilisation effect of surfactants and/or solvent-surface interactions
Providing a highly charged solid, which the various solid components of the dispersion are attracted to.
   These steps perform the general function of bringing together suspended particulates, to create larger ‘flocs’ which (depending on the relative density of particle to fluid) collectively rise to the top or fall to the bottom of the suspending fluid. The present inventors have advantageously identified methods to induce flocculation to assist in the formation of 2D composite materials.

Flocculation is an advantageous step to include in a process as it permits the utilization of large amounts of solvent without the need for significant liquid evaporation or otherwise physical means of obtaining a product. This makes flocculation a widely used process at industrial scales, where time and energy used for the reaction are ideally as small as possible. Given that it is often difficult to obtain a good dispersion of 2D materials in solvents, flocculation of a product will permit recycling of the large volume of solvent likely needed when scaling up the production of 2D-particulate material composites.

The interaction between the particulate material and the 2D material (in the presence of the flocculating agent) results in an increase in the particle size of the composite relative to the particulate material. This arises due to the formation ‘secondary particles’ (aggregates of composite material) in the solvent. Thus, the use of flocculation is advantageous over simple high shear mixing of particulate materials and 2D materials, because larger, bound particles can be formed. These larger particles are beneficial for further processing steps, as larger particles are known to have more predictable properties than nano-sized particles (e.g. nano-sized particles can be difficult to stabilise).

In the methods described herein, the addition of a flocculating agent to the solvent will induce the 2D material and the particulate material to flocculate and form a composite material. Without wishing to be bound by theory, it is thought that inducing flocculation in this manner results in improved interaction between the 2D material and the particulate. This will often result in an increase in particle size due to the interaction between 2D and particulate materials. This results in a more efficient process for making composites of 2D materials than previously demonstrated in the prior art. The increase in particle size may be observed under a microscope, where observable flocs (groups of particles) growing beyond 10 microns in metal oxides and with polymers can be observed. Before addition of the salt, the particle size within dispersion is expected to be the size at which it was made, e.g. 10 nm particles and higher. Generally, only small, unflocculated, particles (e.g. less than 500 nm) are observed with the microscope before addition of the salt. However, larger particles may be visible depending on the preparation method used to form the dispersion.

Flocculated products are advantageous because solvents can be recycled efficiently, as the formed flocculated material is naturally separated from the dispersion mixture during flocculation. This also means that a relatively large amount of solvent can be used for the dispersion of the 2D material, which reduces the risk of aggregation of the 2D material and ensures a homogeneous mixture of the composite.

It will be understood by a skilled person that a 2D material may be defined as a layered material with an in-plane modulus significantly higher than the shear modulus between the layers. Such materials include but not are restricted to, graphene, WS₂, MoS₂ and hexagonal boron nitride. Typically, a 2D material will comprise from 1-10 molecular layers.

A “graphene-based” material refers to a 2D layered material which comprises a hexagonal carbon skeleton, such as graphene, graphene oxide, reduced graphene oxide, functionalised graphene (e.g. fluorinated graphene). Thus, a material that is “not graphene based” refers to materials which could be termed as “inorganic layered compounds”. Thus, the term ‘inorganic compound’ refers to any compound made up of two or more elements which forms layered structures in which the bonding between atoms within the same layer is stronger than the bonding between atoms in different layers. Many examples of inorganic layered compounds have covalent bonds between the atoms within the layers but van der Waals bonding between the layers. The term ‘inorganic layered compound’ is not intended to encompass graphene or graphene derivatives.

The term “non-basic” means that when the flocculating salt is added to deionised water, the pH of the resulting solution is from 1 to 7.5, suitably from 1 to 7.

The term “substantially insoluble” in the context of the present invention means that at least 1000 mass parts of solvent is required to dissolve 1 mass part of solute at standard operating temperatures (e.g. 25° C. and latm pressure). The term “insoluble”, in the context of the present invention means that greater than 10000 mass parts of solvent is required to dissolve 1 mass part of solute.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1

A Nickel Oxide/MoS2 composite was obtained with the following method, which used sodium hydroxide as the flocculating agent.

A dispersion of MoS2 was prepared by high-shear mixing in DMSO, with sodium citrate used as an exfoliation aid. Briefly:

200 ml of sodium citrate (1.84 mg/ml) in DMSO was prepared. To this mixture, 1.005 g of MoS2 (Sigma, 234842, <2 micron powder, 98%) was added. The solution was homogenised for 1 hour at maximum RPM using a L4R mixer, equipped with a ¾ tubular square-hole high-shear stator (Silverson Machines). The solution was kept in a cold water bath throughout homogenising, to maintain the solution temperature below 30-40 degrees centigrade. After homogenising, the solution was transferred to four 50 ml centrifuge tubes and centrifuged for 30 minutes at 2000 RPM (Premiere, Model XC-2450 Series Centrifuge), to yield a brown dispersion. The top 80% in each supernatant was used as the ‘MoS2 dispersion’ This method normally yields a MoS2 dispersion of 0.01-0.02 mg/ml

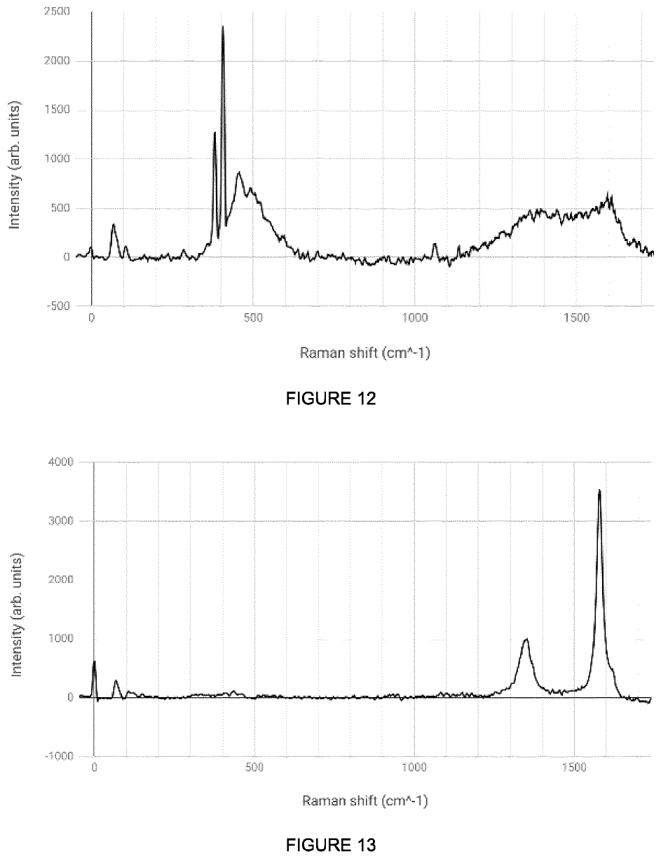

2 ml MoS2 dispersion and 0.01 g nickel oxide (Sigma, <50 nm, 637130) were added into a glass vial and dispersed with a bath sonicator for 10 minutes. 0.2 ml NaOH solution (1M in deionised water) was added, rapidly forming a precipitate from the mixture. The supernatant was removed, and the resulting slurry transferred to a vacuum oven to dry in a vacuum oven at 80 degrees centigrade for 30 hours. The product was analysed with Raman spectroscopy. (FIG. 12)

### Example 2

A ZnO/Graphene composite was obtained with the following method, which used ammonium acetate as the flocculating agent.

A ZnO/Graphene composite was obtained with the following method, which used ammonium acetate as the flocculating agent.

A dispersion of graphene was prepared by high-shear mixing of graphite in DMSO. Briefly:

25 g graphite flakes (<50 micron, Sigma) were added to 500 ml DMSO in a beaker. The solution was homogenised for 30 minutes at maximum RPM using a L4R mixer, equipped with a 32 mm square-hole high-shear rotor/stator assembly (Silverson Machines). A water bath was used to maintain the temperature of the dispersion close to room temperature. After homogenising, the solution was transferred to 50 ml centrifuge tubes and centrifuged for 30 minutes at 2000 RPM (Premiere, Model XC-2450 Series Centrifuge). The top ⅔^{rd} of supernatant in each vial was then centrifuged for a further 30 minutes at 3500 RPM. The top ⅔^{rd} of the resulting supernatants were used as ‘graphene dispersion’. This method usually yields a graphene dispersion of 0.01-0.05 mg/ml

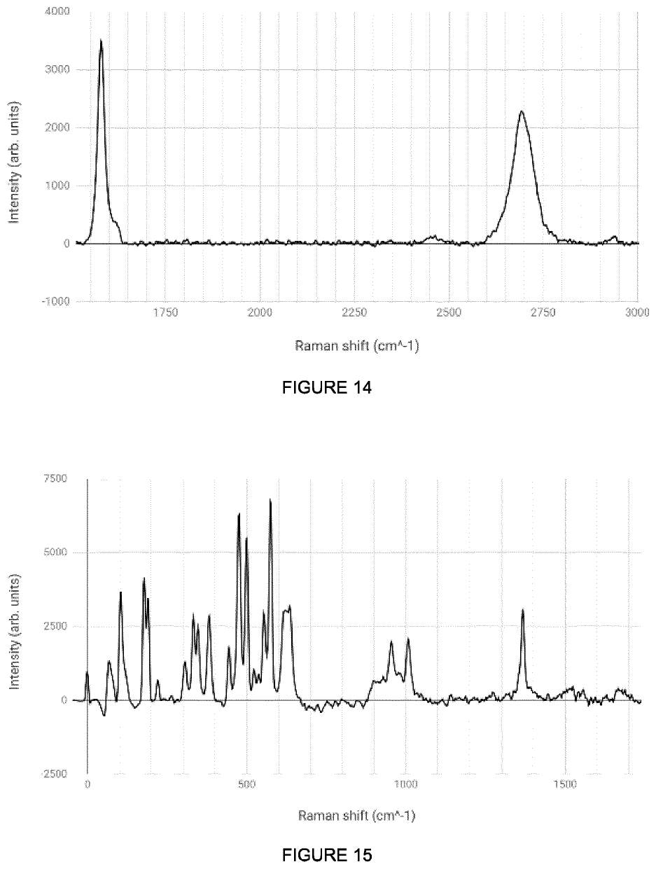

2 ml of the graphene dispersion and 0.01 g zinc oxide (sigma, <100 nm, 544906) were added into a glass vial and bath-sonicated for 10 minutes. 0.2 ml of saturated ammonium acetate was then added to the dispersion to initiate the flocculation. The product formed slowly, yielding large suspended particles which could be observed with a microscope. The suspension was left to evaporate in a vacuum oven for 30 hours at 80 degrees centigrade, yielding a solid which was analysed with Raman spectroscopy (FIG. 13 and FIG. 14).

### Example 3

hBN/ZrO2 composite was obtained using the following method, which used ammonium carbonate as the flocculating agent.

A dispersion of hBN was first achieved by high-shear mixing of hBN in DMSO. Briefly:

200 ml DMSO was added to a 250 ml glass beaker. To this, 1.015 g of hBN (Sigma, 255475, ˜1 micron powder, 98%) was added. The solution was homogenised for 1 hour at maximum RPM using a L4R mixer with ¾ tubular square-hole high-shear stator (Silverson Machines). The solution was kept in a cold-water bath throughout homogenising, to maintain the solution temperature below 30-40 degrees centigrade. After homogenising, the solution was transferred to four 50 ml centrifuge tubes and centrifuged for 30 minutes at 2000 RPM, followed by 15 minutes at 4000 RPM (Premiere, Model XC-2450 Series Centrifuge), to yield a white dispersion. The top 80% in each supernatant was used as the TON dispersion'. This method usually yields a hBN dispersion of 0.008-0.03 mg/ml

2 ml of the hBN dispersion and 0.01 g ZrO2 (5 micron powder, 230693, Sigma-Aldrich, 99%) were added into a glass vial and sonicated for 10 minutes. 0.2 ml saturated ammonium carbonate was then added to the dispersion to initiate the flocculation. The product was dried with a vacuum oven and then analysed with Raman spectroscopy, shown in FIG. 15.

### Example 4

A hBN/ZrO2 composite was also obtained using the following method, which used NaOH as the flocculating agent.

500 ml of NaOH solution (2M in deionised water) is prepared. Then, 1.011 g hBN (Sigma, 255475, ˜1 micron powder, 98%) is added, and the solution was homogenised for 30 minutes at maximum RPM using a L4R mixer, equipped with a 32 mm square-hole high-shear rotor/stator assembly (Silverson Machines). A water/ice bath was used to maintain the temperature of the dispersion close to room temperature. Then, 1.057 g ZrO2 (5 micron powder, 230693, Sigma-Aldrich, 99%) was added to the mixture, and homogenisation was continued under the same conditions for an additional 30 minutes.

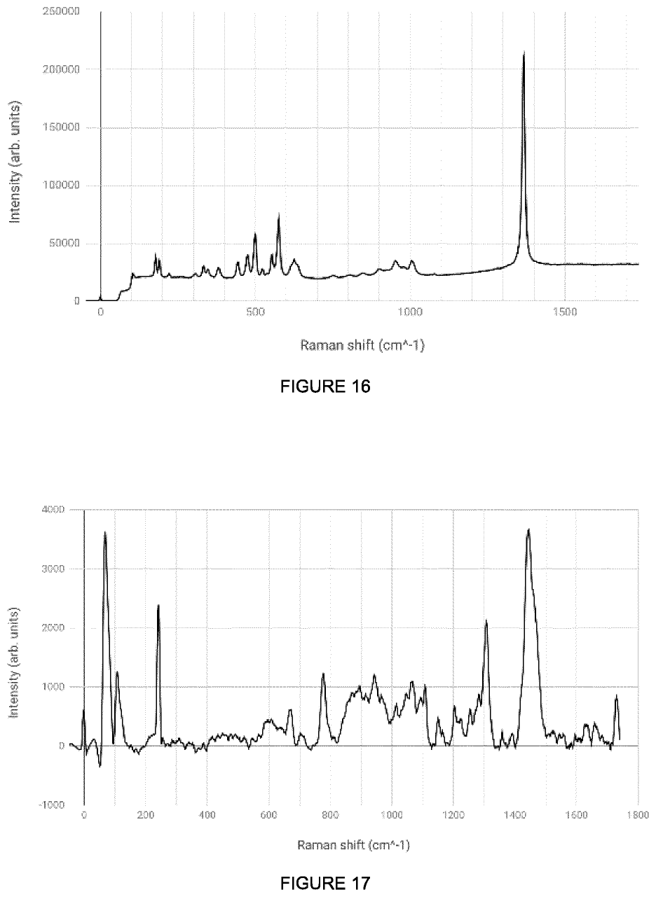

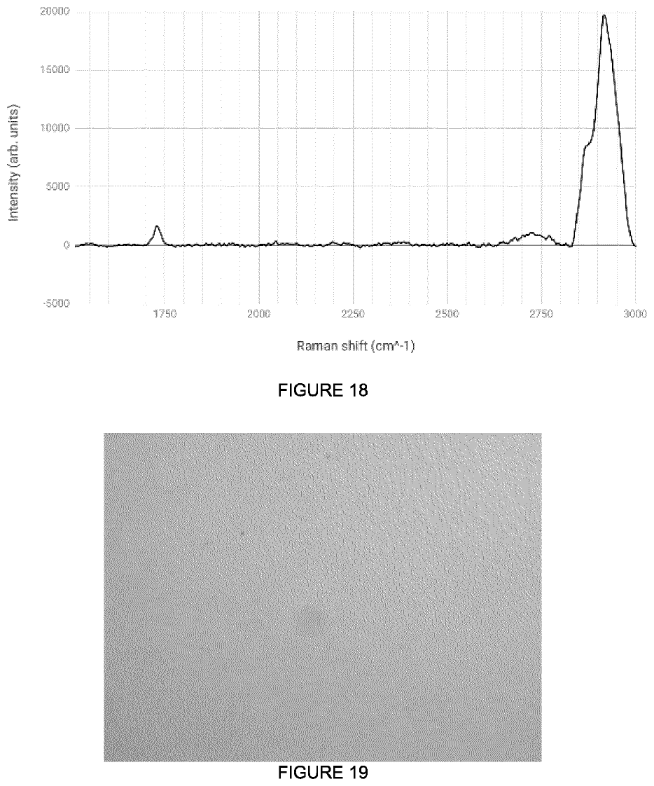

A white flocculation was seen to rapidly form, once homogenisation ceased. An aliquot of precipitate was collected and dried on a hotplate at 70 degrees centigrade. The product was then analysed with Raman spectroscopy, shown in FIG. 16.

### Example 5

A composite between MoSe2 and Polyurethane was formed with the following method, which used ammonium acetate as the flocculating agent, with sodium citrate to enhance the yield of layered material.

A water-based biodegradable polyurethane nanoparticle emulsion was synthesised following the protocol described by Chen et al (2014).

Under inert atmosphere, 10.24 g of Poly-e-caprolactone diol (5 mmol) and 3.99 ml IPDI (19 mmol) were reacted for 3 hours (180 rpm) at 75C. Approximately 0.8 ml of 2-Butanol and 0.71 g of DMPA (5 mmol) were then added against high nitrogen flow. The reaction was cooled down to 45C, 0.696 ml triethylamine (TEA, 5 mmol) was syringed into the reaction flask and the mixture was stirred for 30 minutes. 36 ml DI water was quickly added against vigorous sitting (1200 rpm) for 2 minutes, after which the stirring was brought back to 180 rpm. 0.51 ml ethylenediamine (EDA, 8 mmol) was added and the reaction was stirred for further 30 minutes. The milky colloidal dispersion was collected, centrifuged and washed twice with DI water (3000 rpm, for 15 and 30 minutes) to yield a 15 w % emulsion.

Adapted from Chen, Y.-P., & Hsu, S. (2014). ‘Preparation and characterization of novel water-based biodegradable polyurethane nanoparticles encapsulating superparamagnetic iron oxide and hydrophobic drugs.’ J. Mater. Chem. B, 2(21), 3391-3401. Doi:10.1039/c4tb00069b

A dispersion of MoSe2 was prepared with the following method:

200 ml of sodium citrate (1.84 mg/ml) in DMSO was prepared. To this mixture, 1.005 g of MoSe2 (Alfa, 13112, 325 mesh powder, 99.9%) was added. The solution was homogenised for 1 hour at maximum RPM using a L4R mixer, equipped with a 19 mm square-hole high-shear stator (Silverson Machines). The solution was kept in a cold water bath throughout homogenising, to maintain the solution temperature below 30-40 degrees centigrade. After homogenising, the solution was transferred to four 50 ml centrifuge tubes and centrifuged for 30 minutes at 2000 RPM (Premiere, Model XC-2450 Series Centrifuge), to yield a brown dispersion. The top 80% in each supernatant was then centrifuged at 4000 RPM for a further 15 minutes. Dispersions were left to settle further overnight, then the supernatant was used directly as ‘MoSe2 dispersion’.

To form the composite:

2 ml MoSe2 dispersion and 0.5 ml PU dispersion were added together into a vial and sonicated for 5 minutes. Saturated ammonium acetate (0.2 ml) was added to the mixture under mild agitation. A precipitate formed slowly, and the contents were transferred to a vacuum oven for drying for 30 hours at 80 degrees C. This yielded a transparent, brown film weighing 0.0912 grams. The product was further analysed with Raman spectroscopy, shown in FIG. 17.

### Example 6, MOF-Initiated Flocculation in DMSO Graphene Dispersion

Images of this dispersion were taken throughout the procedure of making the dispersion and the interaction. The metal oxide used was titanium oxide (anatase) and the flocculating agent was the zinc nitrate hexahydrate which instigated the formation of a MOF, ZIF-8. The experimental procedure is as follows:

25 g graphite flakes (<50 micron, Sigma) were added to 500 ml DMSO in a beaker. The solution was homogenised for 30 minutes at maximum RPM using a L4R mixer, equipped with a 35 mm square-hole high-shear stator (Silverson Machines). A water bath was used to maintain the temperature of the dispersion close to room temperature. After homogenising, the solution was transferred to 50 ml centrifuge tubes and centrifuged for 30 minutes at 2000 RPM (Premiere, Model XC-2450 Series Centrifuge). The top ⅔^{rd} of supernatant in each vial was then centrifuged for a further 30 minutes at 3500 RPM. The top ⅔^{rd} of the resulting supernatants were used as ‘graphene dispersion’, yielding solution 1. This method normally yields a graphene dispersion of 0.01-0.05 mg/ml

In a separate beaker, 0.66 g of 2-methylimidazole was then added to 44 g (40 ml) of DMSO, yielding solution 2. 0.375 ml of 1,4-diaminobutane was added to 25 ml of solution 2, yielding solution 3.

In a separate beaker, 0.30 g of Zinc nitrate hexahydrate was added to 44g (40 ml) DMSO, yielding solution 4.

Images of 100 ml graphene dispersion were captured using the camera. 0.5 g of Anatase (Sigma, ˜25 nm, powder) was added to the dispersion, and the mixture was mixed using a sonication bath for 10 minutes. The dispersion was left to rest for a further 10 minutes. Images of the mixture were captured using the camera.

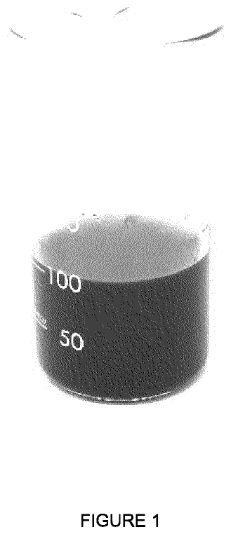

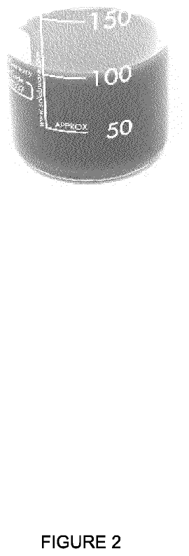

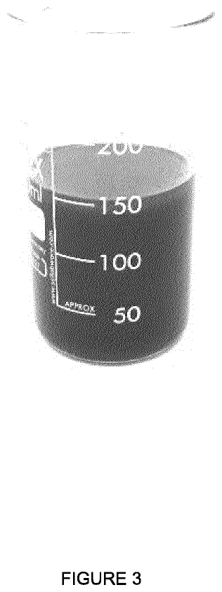

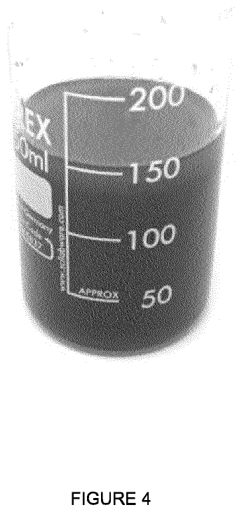

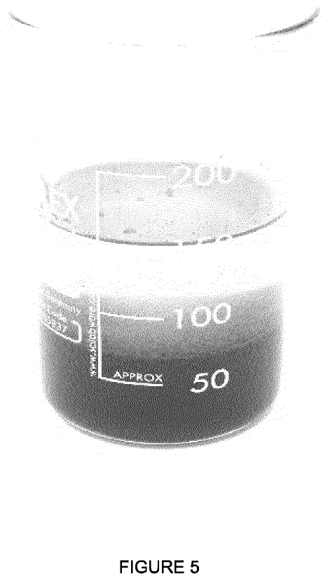

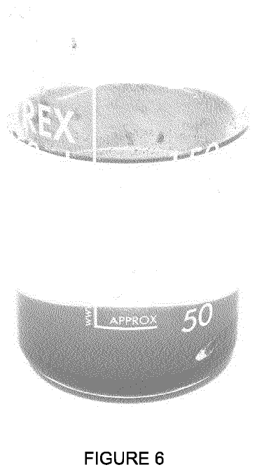

Solution 3 was added to the mixture and mixed for 5 minutes using the sonication bath. Then, 25 ml of solution 4 was added to the mixture, and the mixture was mixed for 5 minutes using a magnetic stirrer and stirrer bar. This initiates the formation of solid crystals of the MOF, ZIF-8, from soluble precursors. Formation of ZIF-8 acted as a flocculant to form a composite between TiO2 and graphene sheets. Photos were taken at regular intervals to show formation of the flocculated product from the dispersion (FIGS. 1-6). The product appears to be a solid comprising both graphene nanosheets, titanium dioxide, and ZIF-8, owing to the dispersion becoming clear, and the ZIF-8 precursors being known to those skilled in the art to likely form ZIF-8 under these conditions.

### Example 7: Ammonium Chloride-Initiated Flocculation when Using Graphene Dispersion in a Acetone:Water Mixture

Images of this dispersion were taken throughout the interaction procedure. The metal oxide used was titanium oxide (anatase) and the interaction agent was ammonium chloride, produced in-situ by reaction of HCl with ammonia.

The experimental procedure is as follows:

In a thoroughly cleaned 500 ml beaker, 2 g Graphite (<50 micron, Sigma) is added to a 3:1 by weight Acetone:water mixture (316 g Acetone to 105 g water). The mixture is shear mixed for 30 minutes at maximum RPM using a L4R mixer, equipped with a 35 mm square-hole high-shear stator (Silverson Machines). A water/ice bath was used to maintain the temperature of the dispersion close to room temperature. After homogenising, the solution was transferred to 50 ml centrifuge tubes and centrifuged for 30 minutes at 2000 RPM (Premiere, Model XC-2450 Series Centrifuge). The top ⅔^{rd} of supernatant in each vial was then centrifuged for a further 30 minutes at 3500 RPM. The top ⅔^{rd} of the resulting supernatants were used as ‘graphene dispersion’. This method normally yields a graphene dispersion of 0.01-0.05 mg/ml

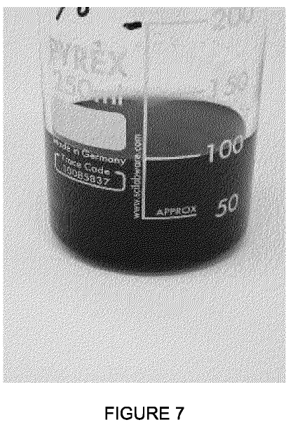

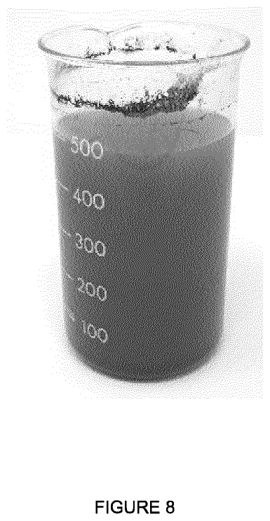

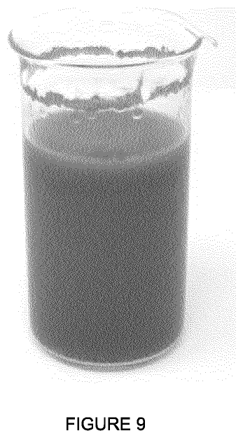

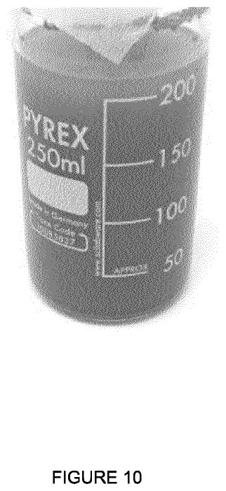

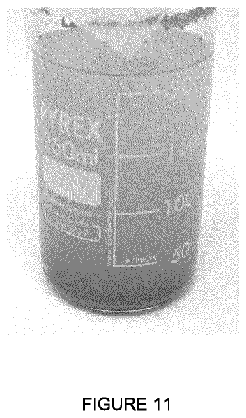

0.2 g TiO2 (Sigma, ˜25 nm, powder) is added to the mixture and it is dispersed by sonication for 10 minutes. Images were taken immediately after and then after 10 minutes. Exfoliated graphene was found to stay in dispersion, while a layer of non-dispersed TiO2 sinks at the bottom, indicating little/no interaction between graphene and TiO2. While mixing with a magnetic stirrer/stirrer bar, 10 ml 1M (aqueous) HCl was added, followed by 10 ml 1M (aqueous) ammonia. The mixture was left to stir for 5 minutes. This formed a precipitate of ammonium chloride which caused the formation of a composite. This is seen to precipitate rapidly, over the course of 10 minutes. Photos from this reaction can be found in FIGS. 7-11.

### Example 8: MoS2 and PU Microscope Study

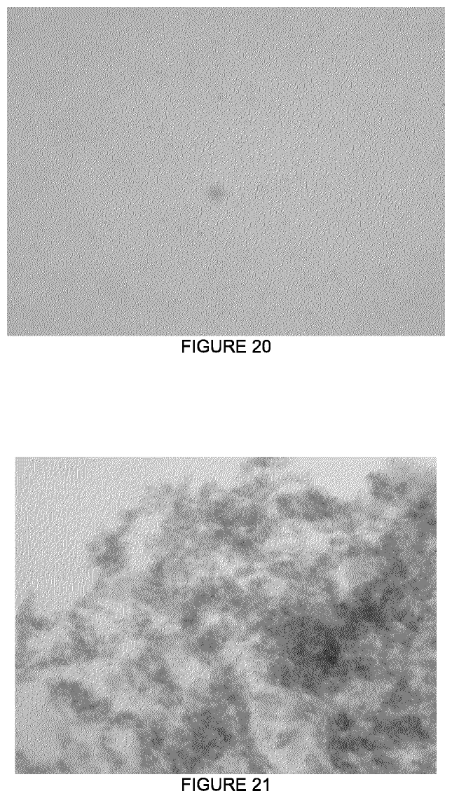

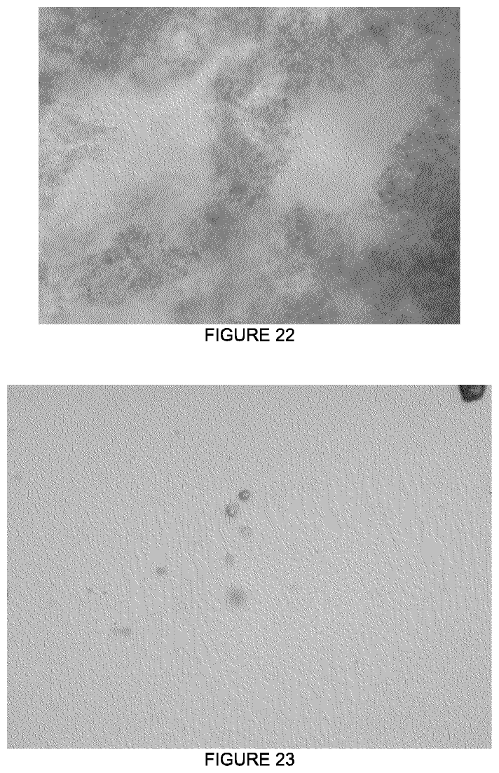

Reaction procedure:
1. 1 ml MoS2 dispersion (as prepared from example 1) was added to a glass vial.
2. 0.1 ml of polyurethane dispersion (as prepared from example 5) was added and dispersed using a bath sonicator for a total of 5 minutes.
3. Images of the dispersion were taken under the microscope using two different magnifications. To image the dispersion, a few drops were placed on a glass slide and a cover slip was placed on top to allow the imaging to take place. (FIGS. 19-20)
4. 0.1 ml of saturated ammonium carbonate was added to the dispersion in the vial, and the mixture was mixed using the sonicator for 30 seconds.
5. Immediately after the vial was mixed, a couple of drops were added to a glass slide and covered with a cover slip. Images during the flocculation process were taken using the microscope. (FIGS. 21-22)

### Example 9: MoSe2 and TiO2 Microscope Study

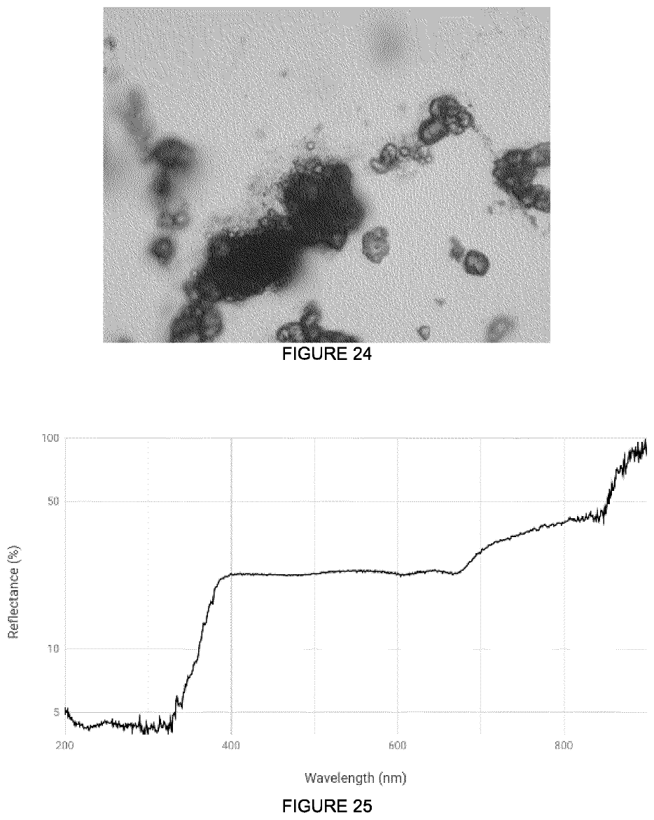

1. 1 ml MoSe2 dispersion (as prepared from example 5) was added to a glass vial. Images were attempted to be recorded with a microscope, but no material was observed.
2. 0.0015 g of anatase powder (Sigma, 637254, anatase, <25 nm particle size) was added to the dispersion and dispersed using a bath sonicator for a total of 5 minutes.
3. Images of the dispersion were taken using the higher magnification (yielding images roughly 140 microns across). To image the dispersion, a few drops were placed on a glass slide and a transparent cover slip was placed on top to allow the imaging to take place. (FIG. 23)
4. 0.1 ml of 1M NaOH was added to the dispersion in the glass vial, and the mixture was mixed using a bath sonicator for 30 seconds.
5. Immediately after the vial was mixed, a few drops of the mixture were added to a fresh glass slide and covered with a new cover slip. A representative image of the flocculation process is shown in FIG. 24.

### Example 10: Synthesis of MoS2/TiO2 Composite

2 ml MoS2 dispersion (as prepared from example 1) was added into a glass vial. 0.01 g anatase (Sigma, 637254, anatase, <25 nm particle size) was added to the dispersion, and the mixture was mixed for 5 minutes in a sonication bath. After sonication, 0.2 ml NaOH solution (1M, in deionised water) was added to the mixture, and flocculation was observed. The solid product settled out rapidly, and it was dried with a vacuum oven for 30 hours at 80 degrees centigrade. UV/Vis Diffuse Reflectance Spectroscopy was performed on the solid product, and the spectrum (FIG. 25) indicates the presence of exfoliated MoS2 and TiO2. The troughs in the spectrum between 550 nm and 800 nm indicate the presence of MoS2, while the feature between 300 nm and 500 nm is likely the TiO2 bandgap.

### Example 11: Synthesis of a MoS2/PU Composite

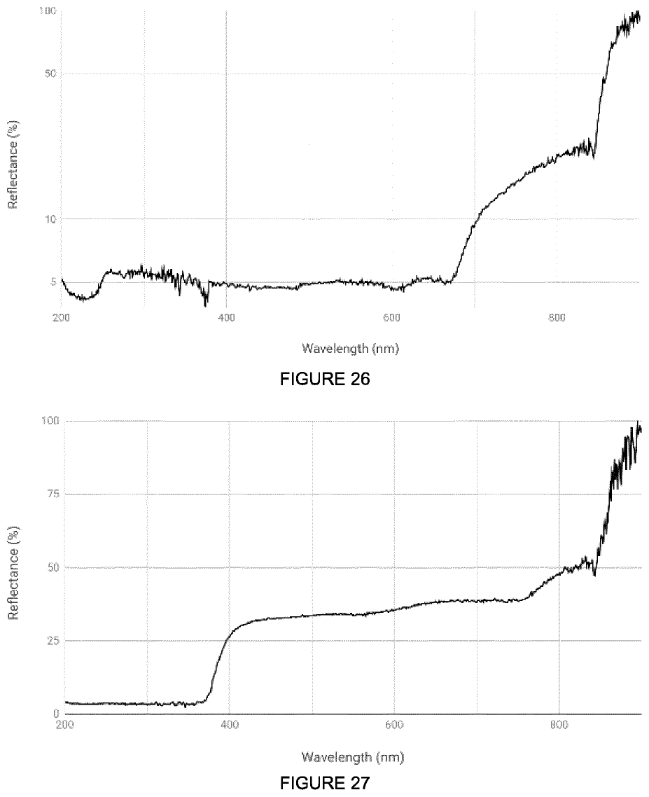

2 ml MoS2 dispersion (as prepared from example 1) was added into a glass vial. 0.5 ml PU dispersion (from example 5) was added also, and the mixture was mixed in a sonication bath for 5 minutes. 0.2 ml saturated ammonium carbonate solution (aqueous) was added, and a flocculation was observed to occur rapidly. The product was collected, then dried in a vacuum oven for 30 hours at 80 degrees centigrade, yielding a dark, slightly transparent, flexible film. UV/Vis Diffuse Reflectance Spectroscopy was performed on the solid product, and the spectrum (FIG. 26) indicates the presence of exfoliated MoS2. The troughs in the spectrum between 550 nm and 800 nm indicate the presence of MoS2—there is not expected to be any obvious contribution to the spectrum from PU as it is mostly a transparent material.

### Example 12: Synthesis of a WSe2/ZnO2 Composite

WSe2 dispersion was synthesised using the same method as used to produce MoS2 dispersion in example 1. Briefly, sodium citrate (0.37 g) was added into 200 ml of DMSO. 1g WSe2 (Alfa, 13084, 10-20 micron powder, 99.8%) was added, and the mixture homogenised for 1 hour in a cold water bath. The resulting suspension was centrifuged for 30 minutes at 2000 RPM. 2 ml of the WSe2 dispersion was added into a glass vial, and 0.01 g ZnO (<100 nm powder, 544906, Sigma-Aldrich) was also added, forming a mixture which was mixed in a sonication bath for 5 minutes. Saturated ammonium carbonate solution (aqueous) was added while gently mixing the vial, yielding a precipitate. The product was transferred to an oven and dried at 80 degrees Celsius for 30 hours, and the solid was analysed with UV/Vis reflectance spectroscopy. The troughs in the spectrum between 500 nm and 800 nm indicate the presence of exfoliated WSe2, while the feature between 300 nm and 500 nm is likely the ZnO bandgap.

### Example 13: Synthesis of a WSe2/PU Composite

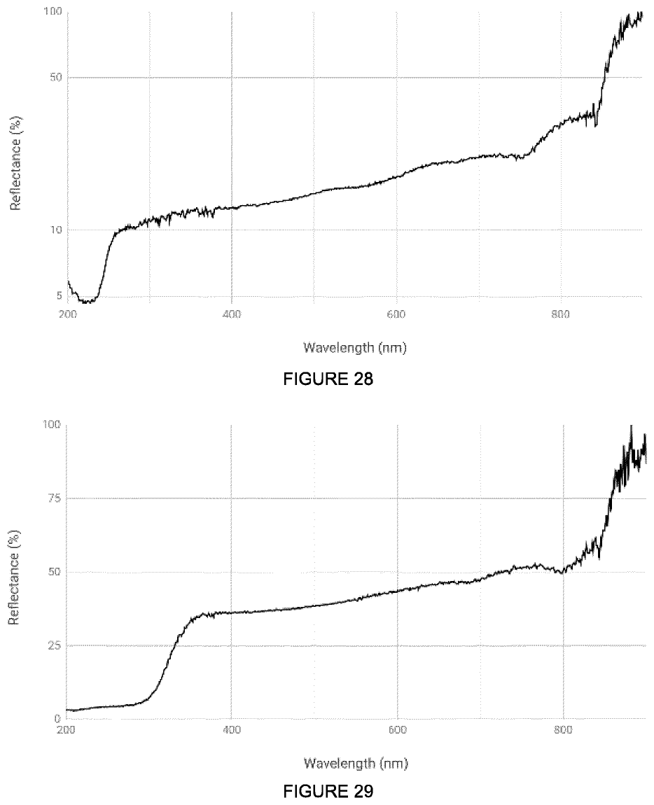

WSe2 dispersion (as prepared from example 12) was added to a glass vial. 0.5 ml PU dispersion (from example 5) was added also, and the mixture was mixed in a sonication bath for 5 minutes. 0.2 ml saturated ammonium carbonate solution (aqueous) was added under mild agitation, and a flocculation was observed to occur rapidly. The product was collected, then dried in a vacuum oven for 30 hours at 80 degrees Celsius in a vacuum oven, yielding a brown, slightly transparent, flexible film. UV/Vis Diffuse Reflectance Spectroscopy was performed on the solid product, and the spectrum (FIG. 28) indicates the presence of exfoliated WSe2 in the troughs between 500 nm and 800 nm.

### Example 14: Synthesis of a MoSe2/SnO Composite

2 ml MoSe2 dispersion (as prepared from example 5) was added to a glass vial. 0.01 g Tin oxide (Sigma-Aldrich, 549657, <100 nm powder) was also added, forming a mixture, which was mixed for 5 minutes in a sonication bath. 0.2 ml sodium citrate (1M, aqueous) was added under mild agitation, and a precipitate formed slowly which was dried for 30 hours at 80 degrees Celsius in a vacuum oven. UV/Vis Diffuse Reflectance Spectroscopy was performed on the solid product, and the spectrum (FIG. 29) indicates the presence of exfoliated MoSe2 in the troughs between 650 nm and 850 nm.

### Example 15: Synthesis of a MoSe2/PU Composite

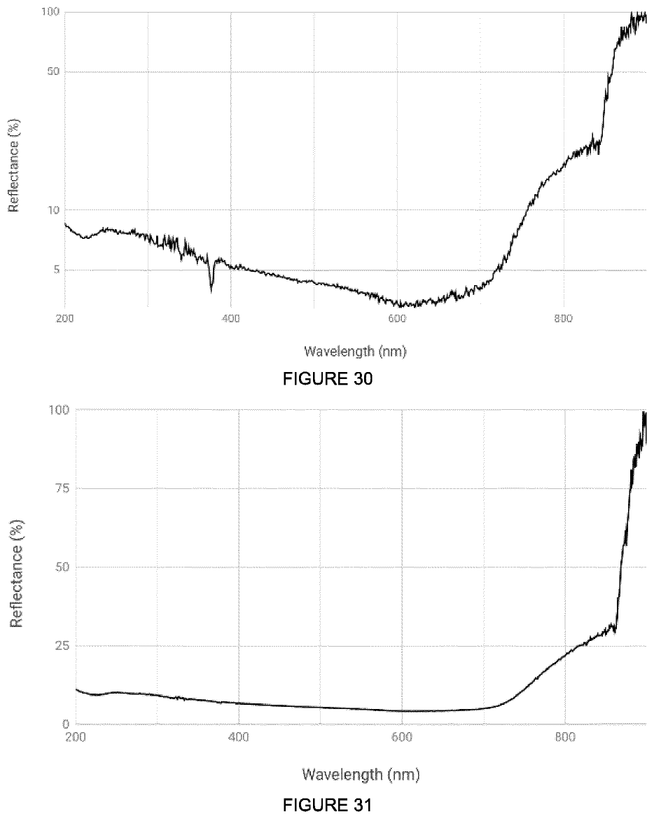

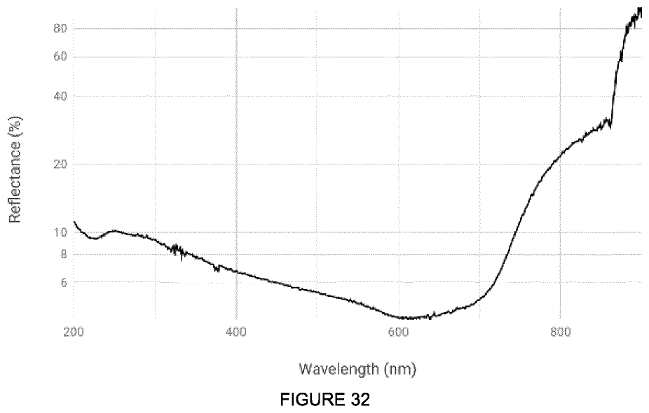

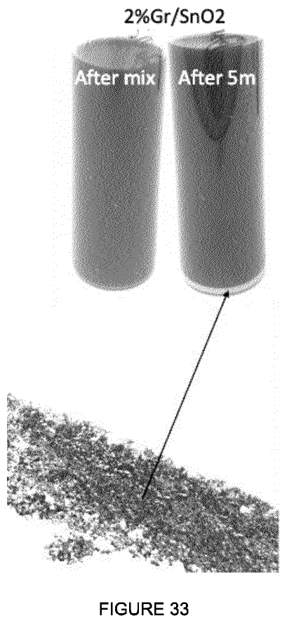

2 ml MoSe2 dispersion (as prepared from example 5) was added to a glass vial. 0.5 ml PU was also added, and the mixture mixed for 5 minutes in a sonication bath. 0.2 ml saturated ammonium carbonate solution (aqueous) was added under mild agitation, and flocculation was observed to rapidly occur. The product was collected, then dried in a vacuum oven for 30 hours at 80 degrees Celsius in a vacuum oven, yielding a dark, slightly transparent, flexible film. UV/Vis Diffuse Reflectance Spectroscopy was performed on the solid product, and the spectrum (FIG. 30) indicates the presence of exfoliated MoSe2 in the troughs between 650 nm and 850 nm.

### Example 16: PEDOT:PSS and MoS2 Composite with Magnesium Hydroxide as a Flocculating Salt

2 g MoS2 was shear mixed at 11 k rpm using a IKA T25 ultra-turrax shear mixer in 250 ml of 3:7 Water:IPA by volume solvent with temperature control (Temperature was maintained below 30 C). Then, the dispersion was centrifuged (Eppendorf 5702) for 20 minutes at 4 k rpm. 80% of the supernatant was collected and centrifuged again at 4 k rpm for 20 minutes. Supernatant was collected and, UV/Vis absorbance recorded was 0.325 at 672 nm. The concentration was estimated to be 0.01 g/L by using an extinction coefficient of 3400 L g m UV/Vis spectroscopy was collected and is reproduced in FIG. 66.

Three samples are prepared with 10 ml of the above dispersion by adding 1 ml of a 2.4 g/L PEDOT:PSS aqueous solution produced by dispersing dry pellets (purchased from Sigma Aldrich, product number 768618) in deionized water. The samples are sonicated for 10 s and magnetically stirred for 5 minutes. Then, selected amounts of 0.01 M LiOH(aq) and 0.01 M Mg(NO₃)₂ are simultaneously added following:

M1: 430 μL LiOH/215 μL Mg(NO₃)₂

M2: 860 μL LiOH/430 μL Mg(NO₃)₂

M3: 1720 μL LiOH/860 μL Mg(NO₃)₂

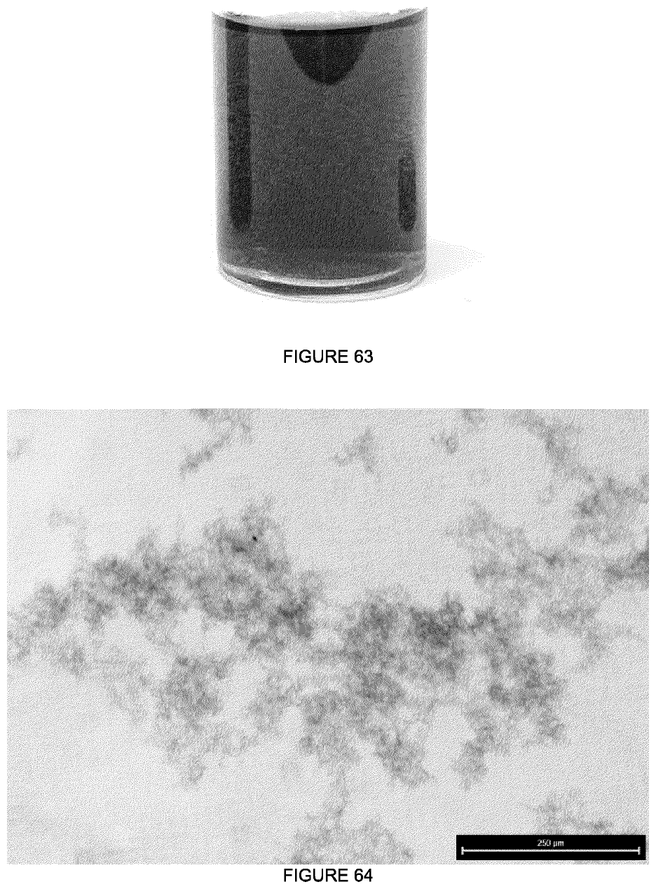

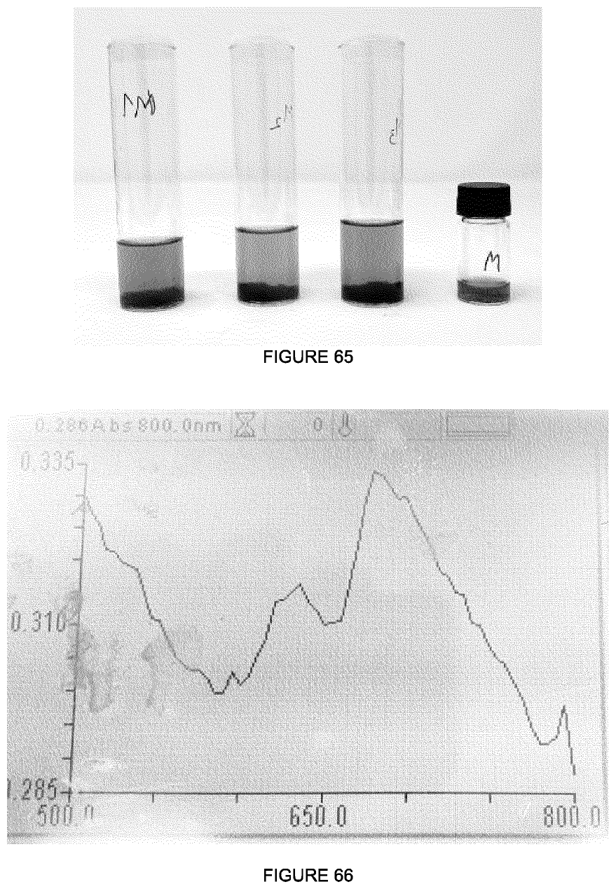

Solid formation is observed immediately after addition (see FIG. 63). The solid is left to settle and optical microscopy is taken. Nothing is seen by optical microscopy in the dispersion before the addition of LiOH and Mg(NO₃)₂. After addition, flocs can be seen (FIG. 64). The supernatant also becomes clear, and no inhomogeneity in the formed particles is seen, indicating that MoS2 and PEDOT:PSS have been integrated together into a composite.

### Example 17: Synthesis of a Combined Composite Between TiO2, Graphene, NiO, and LiCl, with Acetone as an Antisolvent for LiCl

25 g graphite flakes (<50 micron, Sigma) were added to 500 ml NMP in a water jacketed beaker. The solution was homogenised for 30 minutes at maximum RPM using a L4R mixer, equipped with a 32 mm square-hole high-shear rotor/stator assembly (Silverson Machines). Water flow in a cooling jacket was used to maintain the temperature of the dispersion close to room temperature (˜22 degrees Celcius). After homogenising, the solution was transferred to 50 ml centrifuge tubes and centrifuged for 30 minutes at 4400 RPM (Eppendorf 5702). The top ⅔rd of supernatant in each vial was then centrifuged for a further 30 minutes at 4400 RPM. The top ⅔rd of the resulting supernatants were used as ‘graphene dispersion’. This method usually yields a graphene dispersion of 0.25-0.35 mg/ml.

250 mg of titanium oxide and 250 mg nickel oxide (sigma) were added to a suspension of 35 ml of NMP containing 0.3 mg/ml of graphene dispersion, detailed in step 1.

0.12 ml of 5 M LiCl (aq) was added to the suspension to provide an antisolvent interaction species which yielded no more than 5 wt % of the final composite.

This mixture was stirred at 1000 rpm for 15 minutes using a magnetic stirring bar and sonicated periodically for 1 minute after each 5 minutes stirring.

35 ml of acetone (sigma-aldrich) was added rapidly to the suspension under stirring at 200 rpm.

The suspension was left to stand while the antisolvent-accelerated flocculation produced a cascading deposition of dual oxide/graphene composite.

### Example 18: ‘Bottom-Up’ Graphene Mixed with SnO Nanoparticles

Bottom-up multi-layer graphene (obtained from Goodfellow Cambridge Ltd, product number GR006096) is produced from gaseous precursors with a plasma-based process. It has no/little impurities, so is useful for applications requiring high purity. Bottom-up graphene is an alternative method to graphite-based ‘top-down’ approaches to obtaining graphene.

Multi-layer graphene was added to a 1:1 volume solvent blend of water:IPA, at a 0.3g.L-1 concentration.

200 ml of this dispersion was sonicated for 30 minutes while being stirred at 900 RPM with an overhead stirrer. The dispersion was kept at room temperature with a water bath to counteract the heat from the sonication activity.

After this point SnO2 was added to 15 ml of this dispersion to achieve a graphene loading of 2 wt %, and the resulting mixture was sonicated and stirred for a further 5 min and 900 rpm. After this, the solution was sampled for microscopy and left to stand for 5 minutes.

After this time, the solution was again sonicated and stirred for 5 m and 900 rpm. After which, 0.5M aqueous solutions of Li2SO4 and CaCl2 were added to achieve a theoretical wt % of 2% CaSO4. This was again stirred for 5 m at 900 rpm, before being left to stand for 5 m after which the resulting composite was collected for microscopy.

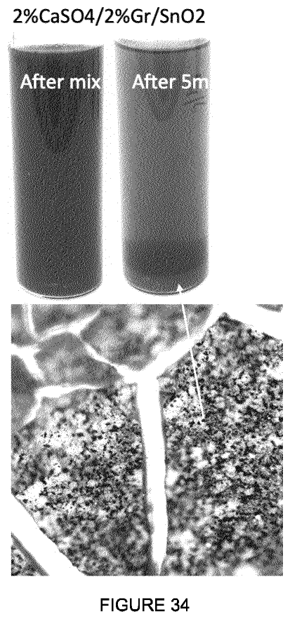

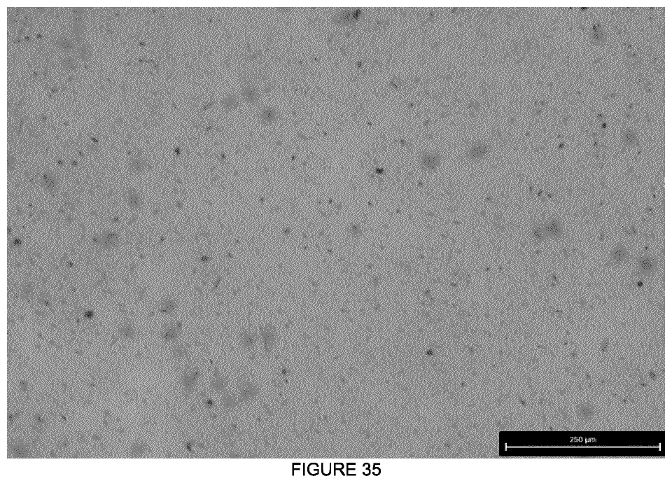

FIG. 34 clearly shows no flocculation occurring in the mixture without CaSO4. In the sample where CaSO4 is added, the solid collected clearly shows graphene material well-mixed amongst the sample.

### Example 19: Tin Oxide with Electrochemically Exfoliated Graphene

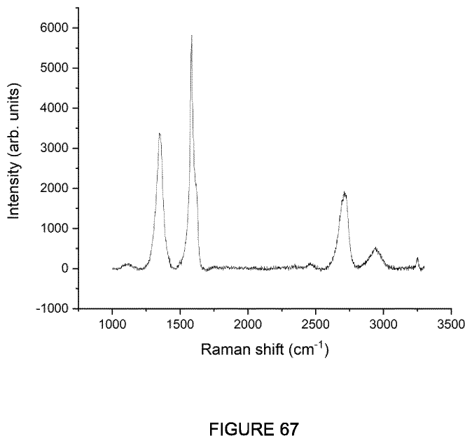

Electrochemically exfoliated graphene (EEG) in NMP (G-DISP-NMP-EG-2+) was obtained from Sixonia Gmbh. As received, it was a suspension of exfoliated graphene at ˜8 mg/ml. This graphene is characterised in FIG. 67 with Raman spectroscopy. It has a FWHM(G) of ˜45 cm⁻¹. This suspension was diluted to 0.15 mg/ml with a 1:1 mixture of distilled water and IPA.

22.5 mg tin oxide (<100 nm, Sigma) was then added to 15 ml of the dispersion from step 1. The mixture was sonicated and stirred/agitated until agglomerates of tin oxide could no longer be seen. Microscopy characterisation of the mixture can be seen in FIG. 35.

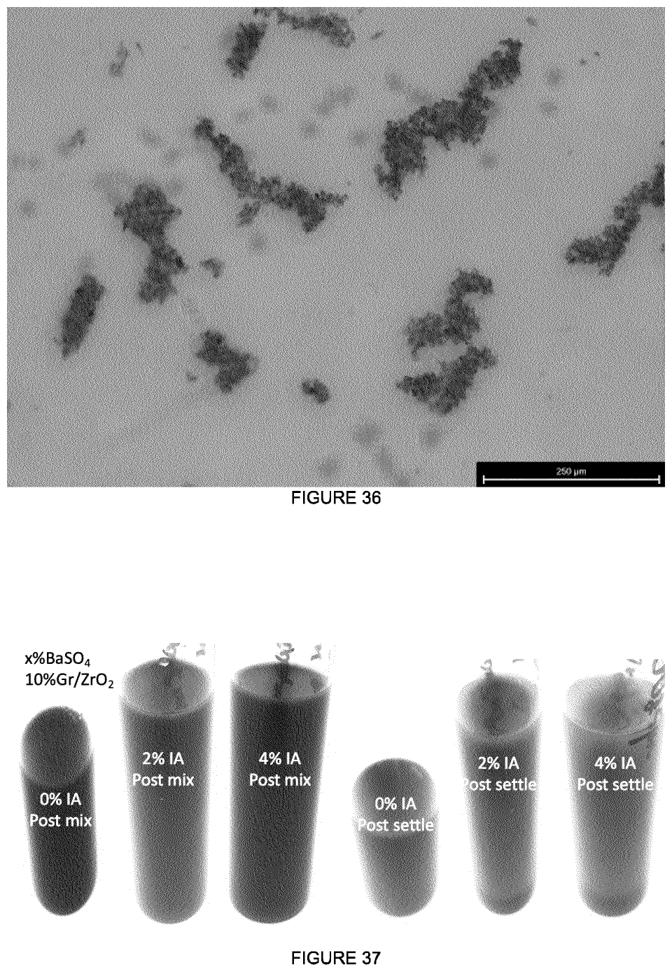

0.5 ml each of 0.5 M phosphoric acid and 0.5 M calcium chloride were added simultaneously over 10 seconds into the mixture, under agitation to ensure good mixing. Within a few seconds, a flocculation could be observed in the suspension. Flocs formed were characterised with optical microscopy in FIG. 36.

Addition of phosphoric acid and calcium chloride salts likely caused formation of calcium phosphate, which is substantially insoluble in water and IPA. It is believed that this rapid precipitation of insoluble salt is what causes such a dramatic change in the suspension, causing flocculation of the particles and thereby forming a well-mixed composite between EEG and SnO particles. Microscopy images (FIGS. 35 and 36) demonstrates the dramatic impact that addition of flocculating salt has on the system.

### Example 20: Tungsten Disulfide and Polystyrene Composite

Aqueous tungsten disulphide dispersion was prepared for this example. In 500 ml of DI water, 5 g sodium cholate was added. Then, 25 g WS2 (2 μm, 99% from Merck) was added and shear was applied for an hour using a Silverson LR4 high shear square-hole mixing head under maximum RPM. To avoid foaming, shear was stopped after 20 minutes, and thereafter shear was pulsed on/off in 10 minute intervals. Temperature of the mixture is kept at 30 C throughout exfoliation. The dispersion is then centrifuged at 2 k rpm for 20 minutes, 1.3 k rpm for 100 minutes and 4 k rpm for 10 minutes to remove any unexfoliated material.

Lithium carbonate was attempted for use as a flocculating salt. Briefly:

A 20 ml of the aqueous WS₂ dispersion and 360 ul of a 1.1% aqueous polystyrene solution (200 nm particle size, purchased from Merk) is slightly sonicated and stirred magnetically. 1.260 ml of 0.1 M LiOH is added and the dispersion is stirred for 10 minutes. Then, CO₂(g) is bubbled through for a few minutes in order for the Li₂CO₃ to form. Foaming issues caused loss of product, but rest of dispersion is left to settle. No clear solid is formed immediately, but a white solid is observed after settling overnight and a white solid is observed. The white colour indicates not much WS2 has been removed from the dispersion and incorporated within the solid.

To improve the amount of product collected, this procedure was repeated with sodium aluminate as the flocculating salt. Briefly:

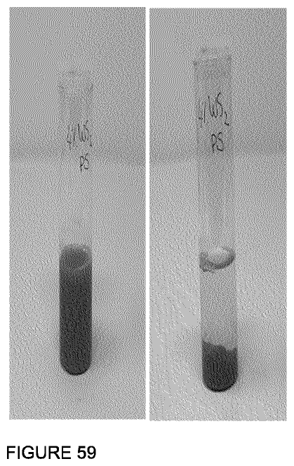

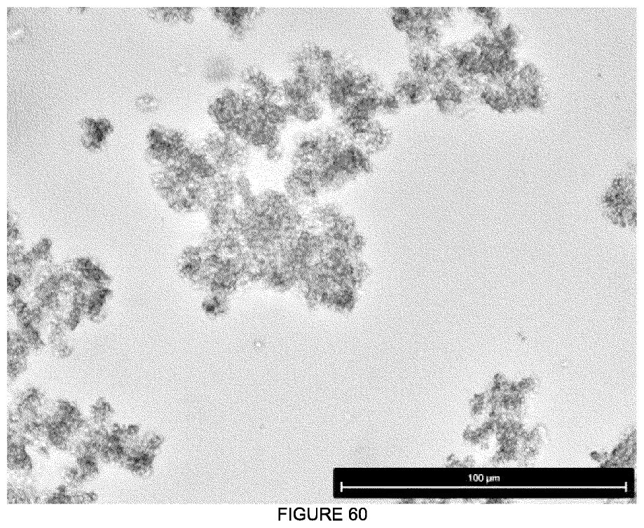

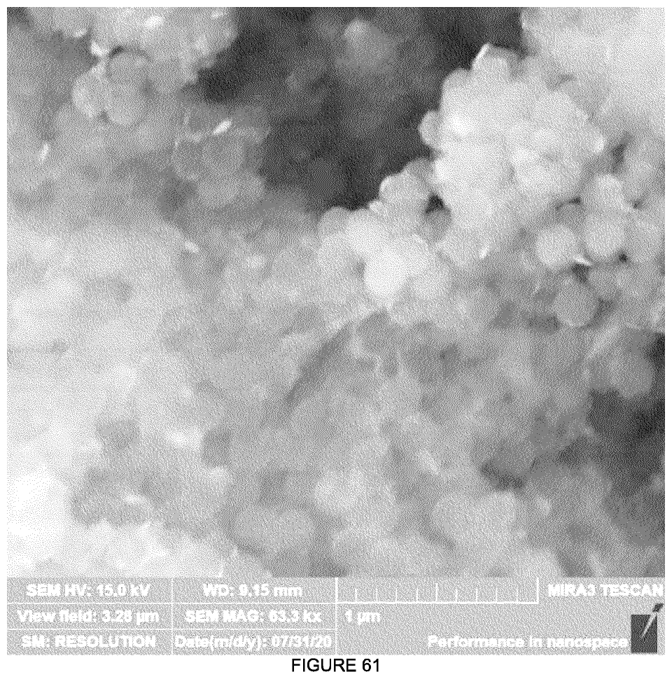

20 ml of the aqueous WS₂ dispersion and 360 ul of a 1.1% aqueous polystyrene solution (200 nm particle size, purchased from Merk) is sonicated for 10 seconds then agitated on a magnetic stirrer for 5 minutes. 0.320 ml of a 0.1 M NaAlO₂ solution is added and solution is stirred further over 5 minutes to ensure homogeneous dispersion of components. Then, 0.320 ml of 0.1 M HCl was added and solid formation was observed within a few seconds. The supernatant also becomes clear, and no inhomogeneity in the formed particles is seen, indicating that WS2 and PS have been integrated together into a composite. Optical and scanning electron microscopy are reproduced in FIGS. 59-60 and 61.

### Example 21: Zirconium Oxide and Electrochemically Exfoliated Graphene (EEG) and Barium Sulphate

Electrochemically exfoliated graphene (EEG) in NMP (product code G-DISP-NMP-EG-2+) was obtained from Sixonia Gmbh. As received, it was a suspension of exfoliated graphene at ˜9 mg/ml. This suspension was diluted to 0.15 mg/ml with a 1:1 mixture of distilled water and IPA.

This solution was sonicated and stirred for 30 m and 900 rpm (stirred with an overhead stirrer)

ZrO2 (<5 micon, Sigma-Aldrich, product number 230693) was then added to achieve a graphene loading of 10 wt %. The mixture was then sonicated and stirred for a further 5 min at 900 rpm (stirred with an overhead stirrer). After this, 15 ml of this solution was removed for microscopy and left to stand for 5 minutes.

30 ml of the parent solution was combined with 105 uL of aqueous 0.1M H2SO4 and Ba(OH)2 to achieve a 2 wt % theoretical barium sulfate loading. Solution was stirred and then sampled, before being left to settle for 30 minutes.

This was repeated with 210 ul of H2SO4 and Ba(OH)2 to achieve a 4 wt % barium sulphate loaded material.

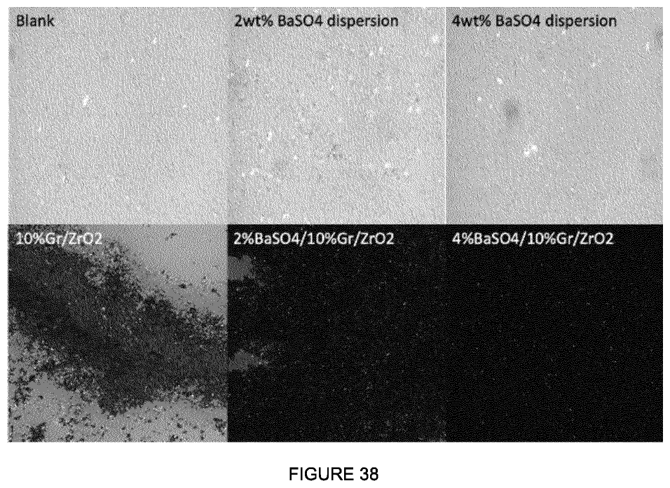

FIGS. 37 and 38 show the effect of Barium Sulphate (referred to as IA in the images) on the mixture of ZrO2 and EEG. After 30 min settling, the sample with the IA appears to have a clearer supernatant than the control sample with no IA. This alone indicates that the IA successfully induces flocculation. However, microscope images of the dispersion after IA addition (larger particles formed) and reflectance microscope images of the solid formed indicate successful formation of a graphene/ZrO2 composite. The amount of solid formed appears to be largely independent of the amount of IA added, beyond 0%.

### Example 22: Comparative Examples: ‘bottom-up’ Graphene with Lithium Phosphate and Zinc Oxide

Bottom-up multi-layer graphene (MLG) (obtained from Goodfellow Cambridge Ltd, product number GR006096) is produced from gaseous precursors with a plasma-based process. It has no/little impurities, so is useful for applications requiring high purity. Bottom-up graphene is an alternative method to graphite-based lop-down' approaches to obtaining graphene.

MLG is added to 3:7 IPA:Water volumetric mixture to make a 0.3 mg/ml suspension. This mixture is sonicated and stirred for 30 minutes to make a graphene dispersion.

294 mg ZnO (<50 nm, Sigma-Aldrich) is added to 20 ml of the graphene dispersion. This mixture is sonicated and agitated for a further 10 minutes. This ensures dispersion of the ZnO in the first graphene dispersion. After 4 hours of being left with no agitation, no settling can be observed in the mixed dispersion. Microscope imaging of the dispersion indicates that there is little flocculation in the liquid.

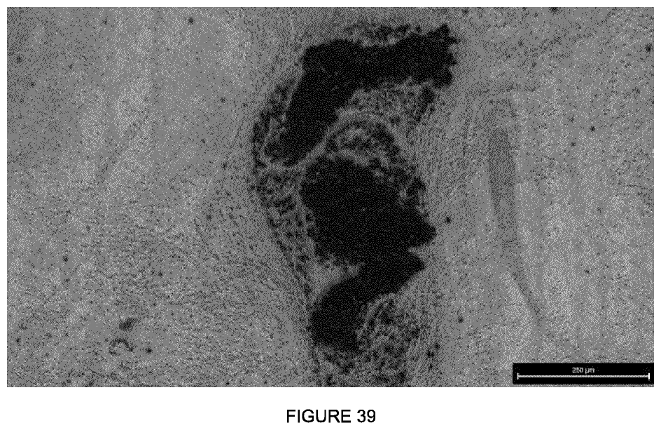

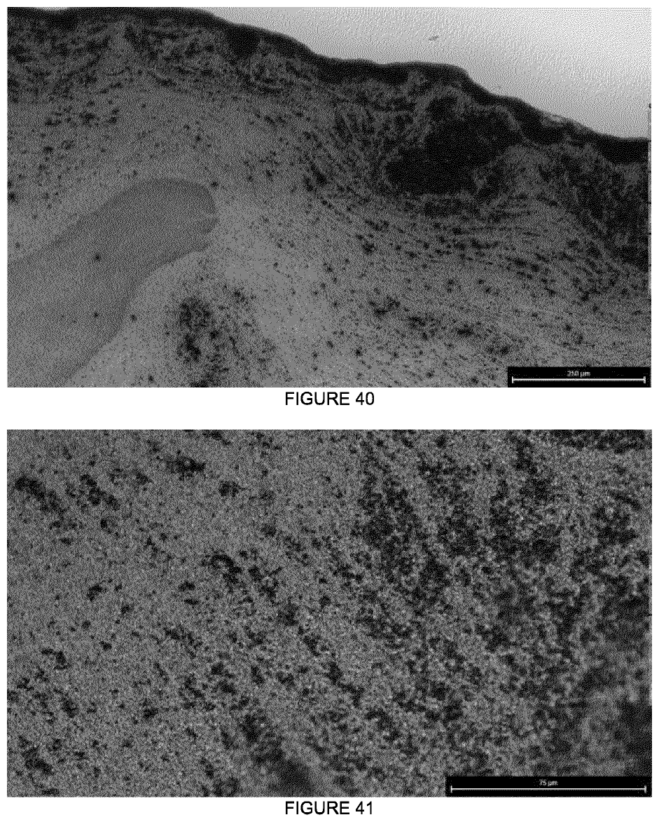

A small amount of this dispersion is removed and dried on a hotplate to make a continuous film. Significant aggregation of graphene can be seen as large black shapes in the film surface. These are imaged further in FIGS. 39-41. Graphene aggregation indicates that there is little attachment of the graphene to the metal oxide surface. The separation of graphene and metal oxide shows that a flocculating salt is required to attach the two materials before drying.

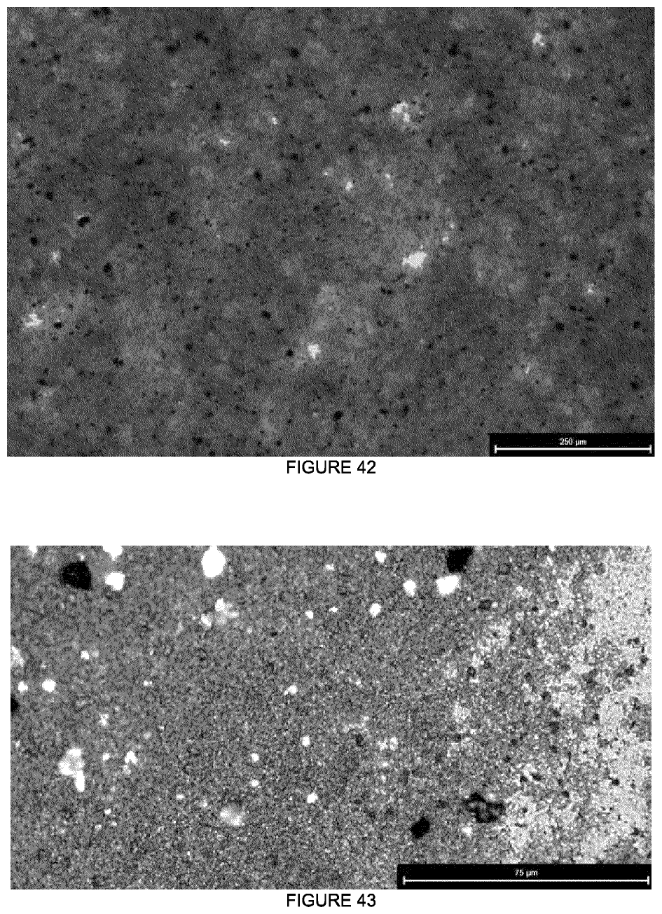

To compare with the effect of adding a flocculating salt, the above steps are repeated, but this time with the formation of lithium phosphate as a flocculating salt (from addition of LiOH and phosphoric acid). This time, no large-scale aggregates can be observed. The sample looks the same across the whole film, indicating that graphene is well-adhered to the zinc oxide. This homogeneous film is imaged in FIG. 42.

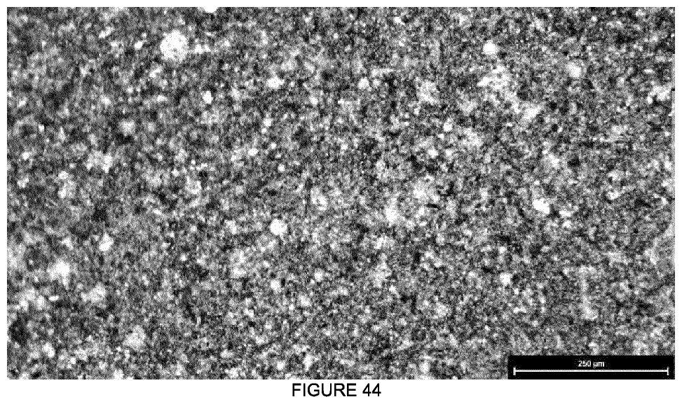

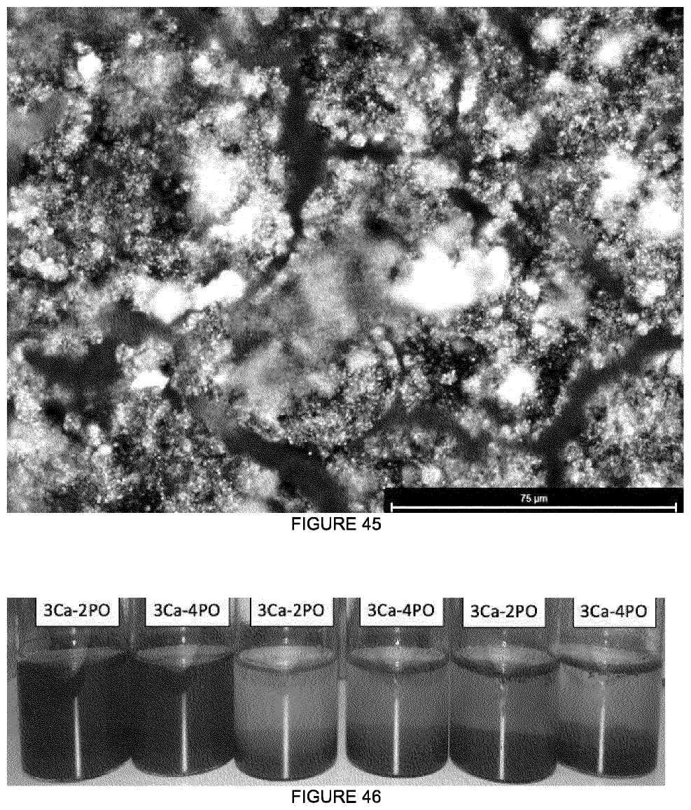

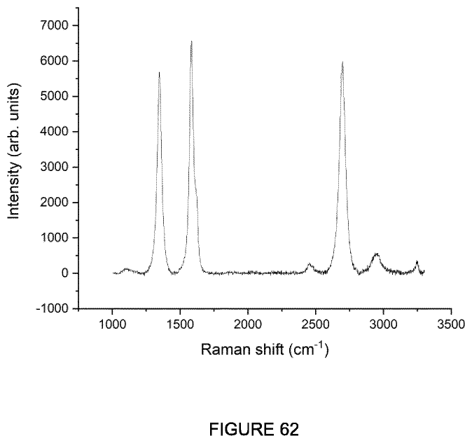

IPA/water in 3:7 volumetric mixture is a useful dispersing medium for graphene as it is constituent of cheap, environmentally benign solvents. However, there are more expensive alternatives that offer better dispersion of graphene. To compare the effect of using a ‘better’ solvent for graphene, FLG (Few Layer Graphene, obtained from Goodfellow Cambridge Ltd, product number GR006094) was dispersed in Cyrene (Dihydrolevoglucosenone; Sigma-Aldrich, product number 807796) at 0.1 mg/ml concentration. Without the use of cyrene, preparation of graphene of this type (few-layer, rather than multi-layer) is impossible. This graphene was characterised by Raman spectroscopy in FIG. 62. A FWHM(G) of 36 cm⁻¹ was measured. A dispersion was prepared with ZnO with the same techniques described earlier in this example, with the same ratio of ZnO and graphene material. A control sample of ZnO and graphene without flocculating salt shows no obvious settling overnight. Dried FLG/ZnO film without flocculating salt can be seen in FIG. 43; graphene agglomerates can be clearly seen and there is little association between the graphene material and the metal oxide. When lithium phosphate (˜5%, via 0.1 M phosphoric acid and 0.1M LiOH, both solutions aqueous) is added as a flocculating salt, a composite forms rapidly. Imaging (FIGS. 44-45) of a dried film of this composite indicates excellent mixing of the graphene and the metal oxide materials to form a solid.

Quality improvements summary of graphene material in ZnO metal oxide:

Bad solvent (Water:IPA 70:30)<Good solvent (Cyrene)<Bad solvent+lithium phosphate<<Good solvent+Lithium phosphate

### Example 24: ZrO2 with Calcium Phosphate—Comparative Screening of Salt Addition and Composition

Electrochemically exfoliated graphene (EEG) in NMP (product code G-DISP-NMP-EG-2+) was obtained from Sixonia Gmbh. As received, it was a suspension of exfoliated graphene at ˜8 mg/ml. This suspension was diluted to 0.1 mg/ml with distilled water. This suspension was sonicated for 30 mins to form a ‘graphene dispersion’.

100 ml of this graphene dispersion was combined with 190 mg of ZrO2 (5 micron, sigma) to give a theoretical Gr weight percentage of 5%. This was sonicated for 5 minutes with additional agitation from an overhead stirrer.

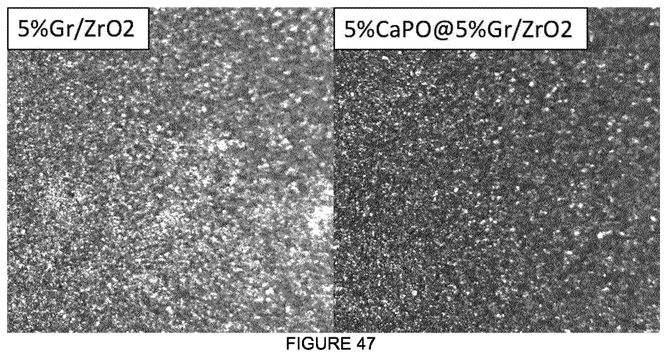

Several samples were produced from this mixture. Calcium phosphate (theoretical product: CaHPO4.2H2O) was produced from different amounts of calcium chloride (0.5 M, aqueous) and ammonium phosphate (0.1 M, aqueous). Increasing salt content (0%, ˜2%, ˜4%, ˜8%) showed a clear increase in ‘graphene incorporation’ between 0% and ˜4%, but showed little obvious increase in graphene incorporation between ˜4% and ˜8%. Images can be seen clearly in FIG. 46. Little difference was also seen between different molar ratios of the salt constituents.

### Example 25: SnO with Bottom-Up Graphene—Conductivity Comparison

Bottom-up multi-layer graphene (MLG, obtained from Goodfellow Cambridge Ltd, product number GR006096) is produced from gaseous precursors with a plasma-based process. It has no/little impurities, so is useful for applications requiring high purity. Bottom-up graphene is an alternative method to graphite-based lop-down' approaches to obtaining graphene.

MLG was dispersed in 100 ml NMP for 30 minutes using sonication and stirring to give a concentration of 0.3 g.L-1. Tin oxide was added to give a 2% Gr to solid ratio, and the mixture was sonicated and stirred for a further 5 minutes.

10 ml of the mixture was removed to function as the control sample. To the remaining solution, 1M Li2SO4 (aqueous, to make 4% theoretical solid loading of salt) was added to flocculate the product. Both samples were left to settle for 24 hours.

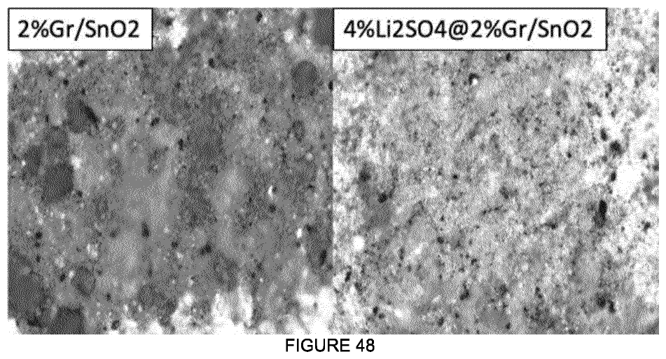

Settled material from both samples (control and with Li2SO4) were both washed with acetone and dried in ambient conditions. The resulting solids were then each diluted with NMP to form a slurry with ˜25% solids content. 33 uL of each slurry was applied using a doctor blade to an interdigitated electrode (DropSens: DRP-IDEAU200) and dried on a hotplate at 80 degrees C. for one hour. Dried electrodes coated with samples can be seen in FIG. 48.

Resistance of the materials on the electrodes was measured with a multimeter (Keithlev DMM6500). Results are reported in the table below:

| Sample number | Electrical resistance |
|---|---|
| Control (No Li2SO4) | 3.4 MΩ |
| Improved sample (With Li2SO4) | 1.3 MΩ |

Electrical conductivity is one of the most desired results from the addition of graphene to a composite material. These data show that, the use of a flocculating salt advantageously facilitates the creation of higher conductivity composite materials. This is believed to be due to the greater inclusion of graphene and the higher homogeneity of a composite assembled using a flocculating salt.

### Example 26: Surfactant-Stabilised Graphene with Copper Oxide, Using Barium Sulphate as a Flocculating Salt

A surfactant-stabilised aqueous dispersion of FLG (same type as used in example 22) was prepared by adding 20 mg of the graphene powder to 200 ml of deionised water containing 20 mg of polyvinylpyrrolidone (Sigma) while under sonication and stirring at 1500 rpm. Stirring was carried out by a SciQuip Basic overhead stirrer and sonication in a Cole-Palmer 40 kHz sonication bath. Stirring and sonication were performed for 30 minutes in total. Graphene dispersion quality and homogeneity were validated under high resolution optical microscopy.

200 mg of copper (II) oxide (Sigma) was added to 40 ml of the dispersion formed in step 1 for a final graphene composite content of <2%.

0.1 M Barium hydroxide was added to the mixture in molar quantities to yield a (theorised) maximum of 10 wt % barium sulphate in the final composite, according to the reaction: Ba(OH)2+H2SO4→BaSO4+2H2O

The above mixture was stirred at 1200 rpm using a magnetic stirrer bar for 15 minutes and sonicated for one minute for every 5 minutes of stirring.

The mixture was divided into two; a control sample with only Ba(OH)2 was set aside. The other 20 ml was processed as below:

A 1.2 molar excess of 1 M sulphuric acid was added slowly under gentle stirring to the mixture to facilitate the complete reaction and the formation of a barium sulphate flocculating agent of no more than 10 wt % final composite.

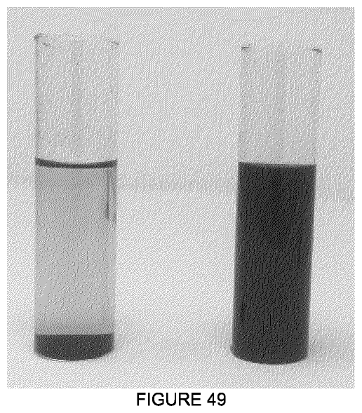

The two mixtures were left to stand for 8 hours. Photographs of the product formed with and without the addition of sulphuric acid are included in FIG. 49.

The absence of significant flocculation in the control sample (with only Ba(OH)2) suggests that formation of insoluble salts is dramatically more efficient than soluble salts. Barium sulphate is known to be substantially insoluble in water, so serves as a useful flocculating salt to make graphene-metal oxide composites from water-based dispersions of graphene.

### Example 27: MOF-199 with ZrO2 and Graphene

MOFs are an exciting new class of materials, with many varied properties and uses. MOFs are useful flocculating salts as they are insoluble in many solvents. The resulting composite with inclusion of a MOF is likely to have many uses. A well-known MOF (HKUST-1, otherwise known as MOF-199) with Cu²⁺ as the metal centre is used in this example.

30 ml of graphene-PVP dispersion (as prepared in example 26) was combined with 147mg of ZrO2 to achieve a graphene loading of ˜2%, this mixture was sonicated and stirred to achieve a uniformly distributed solution. To this, 21 mg of trimesic acid and 450 ul of 1M Copper nitrate trihydrate was also added, and the mixture was vigorously stirred for 5 minutes with a magnetic stirrer bar.

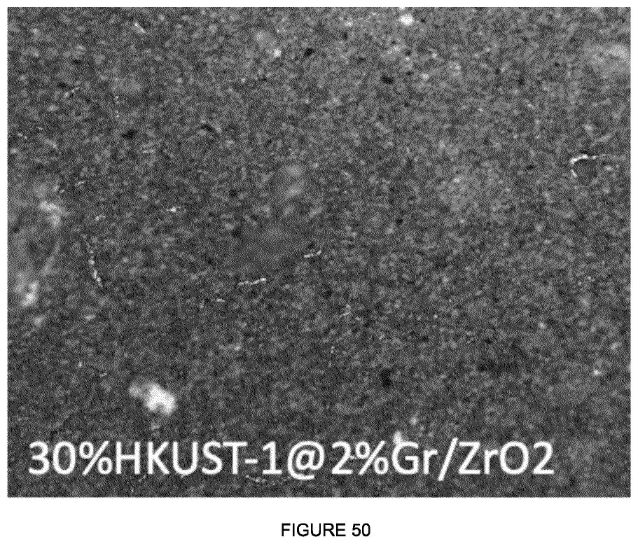

To this mixture, 32 ul of diaminobutane was added, causing immediate flocculation throughout the mixture, leaving behind a clear supernatant. The mixture was stirred for a further minute, before being allowed to settle, then washed with acetone and spread into a film and dried, before being analysed with optical microscopy (FIG. 50). Diaminobutane is known to those skilled in the art to increase the speed of formation of the MOF.

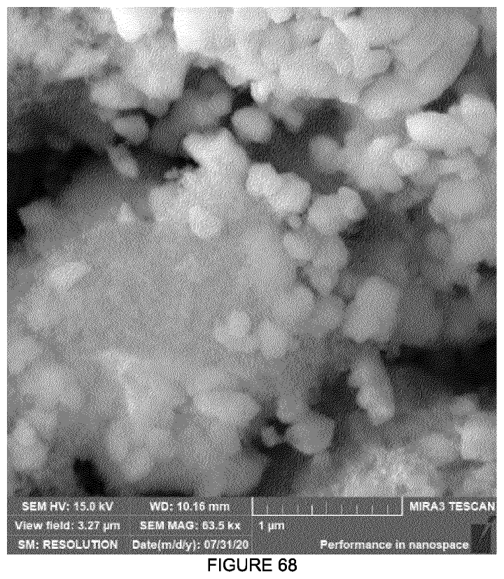

Microscope images show a blue-grey colour. This indicates inclusion of graphene (white zirconia becomes grey, and small black particles of graphene and partially aggregated graphene can be seen). The blue tint shows the inclusion of MOF-199. SEM (FIG. 68) shows entrapment of graphene and MOF together onto the surface of ZrO2 particles.

### Example 28: Comparative Example: Multi-Layer Graphene (MLG) with TiO2

Graphene dispersion from example 18 (0.3 mg/ml solids, in 1:1 IPA:water volumetric mixture) is used in this example.

TiO2 (25 nm, Anatase structure, Sigma-Aldrich) is added to make a 2w % gr to total mass of combined TiO2/graphene solids.

This mixture is sonicated and stirred for five minutes at 900 rpm to ensure good mixing.

Centrifugation (a common solid-liquid separation technique) is then used to attempt to collect the two mixed materials in the form of a composite. Centrifugation is performed at 4.4 k RPM over 30 minutes in a (Eppendorf 5702) centrifuge.

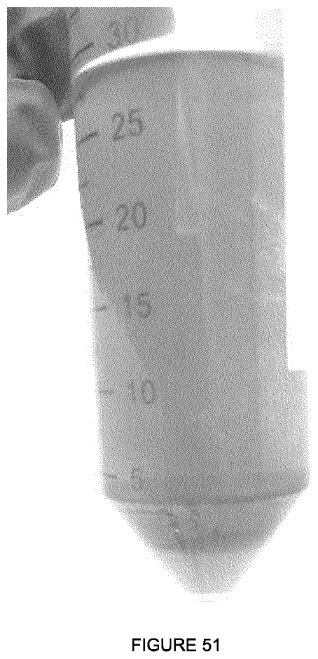

A photograph of the centrifuge tube after centrifugation (FIG. 51) clearly shows separate layers of TiO2 (white) and graphene (black) on top of the TiO2. The suspension is also still slightly black—even after this degree of centrifugation, graphene is still suspended in the system.

This demonstrates one of the typical issues with processing mixtures of metal oxides and graphene—as metal oxides are typically twice as dense as graphene, unequal separation of the two materials is likely during centrifugation. Centrifugation is normally necessary to remove highly dispersed materials from a dispersion. However, in this example, separation in this manner does not lead to a well-mixed composite material.

### Example 29: Comparative Example: MLG with TiO2—Ground in Mortar/Pestle

An alternative to solution processing of 2D/particulate materials is mechanical grinding of the materials.

10 mg of MLG (the same as used in example 18) was added to 490 mg TiO2 (the same as used in example 28).

750 uL of IPA and 750 uL of distilled water were added to the powders, and the mixture ground thoroughly for 5 minutes by hand in a mortar and pestle.

The resulting grey paste was spread into a film and dried.

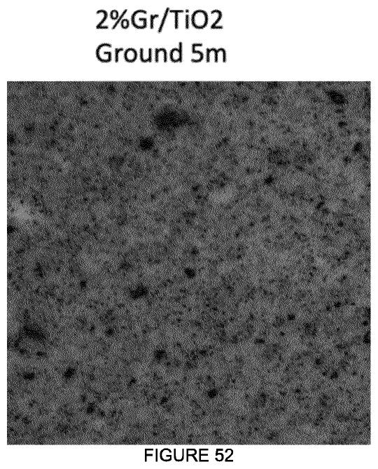

Low-magnification microscopy of the formed film (FIG. 52) shows that large agglomerates of poorly mixed graphene material and poorly mixed TiO2 material still remain. To improve mixing, much longer mixing times would be needed. Long mixing times are not appropriate for large-scale production.

### Example 30: PVDF/MLG Composites with Phosphate Flocculating Salt

PVDF is an important engineering polymer with high chemical resistance and inertness. Compositing with graphene is expected to be difficult as both graphene and

PVDF are extremely inert. Beyond PVDF, this type of solid-state mixing of 2D materials and pre-polymerised polymers is expected to be beneficial for many other types/classes of polymers. Of particular note is the absence of a dissolving/melting step for the polymer. This increases process scalability and facilitates use of high melting point polymers or polymers that are difficult to dissolve.

1) PVP (Average mw 10,000-Sigma-Aldrich) was added to distilled water to make a 3 g/L solution. MLG (the same used in example 18) was added to 60 ml of this solution to make a 0.3 g/L suspension. This mixture was sonicated at room temperature for 30 minutes to disperse the graphene material.

2) 882 mg PVDF was added to 3 ml IPA (to assist mixing with water), and the slurry added into the dispersion from step 1. The mixture was then sonicated and agitated for a further 10 minutes.

3) 21 ml of the mixture from step 2 was used to demonstrate a flocculating salt. Calcium phosphate (substantially insoluble in water) was formed from 0.108 ml 1M CaCl2 and 0.845 ml 0.1M Na2HPO4 under vigorous stirring over 2 minutes.

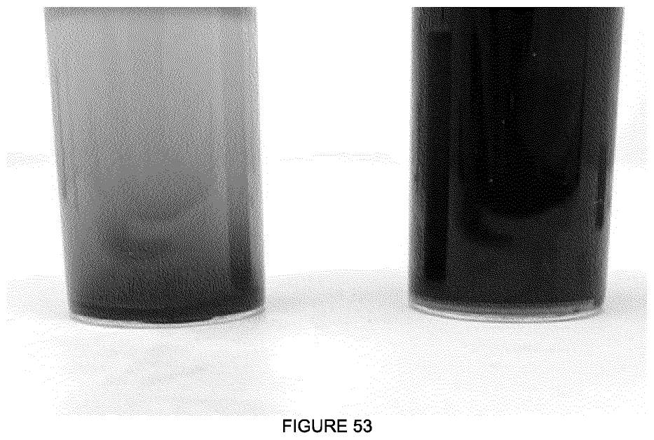

4) An additional 21 ml of the mixture from step 2 was set aside to be a control mixture. This sample and the mixture from step 3 were left to settle for ˜16 hours. Very little settling was observed in the control mixture, but the supernatant from the sample from step 2 appeared to become transparent due to the increased speed of settled solids (FIG. 53).

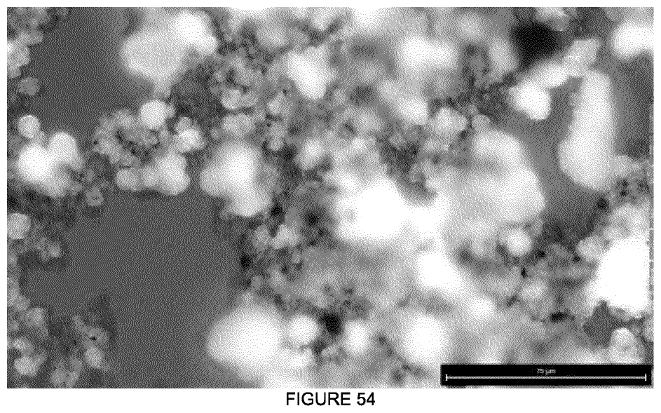

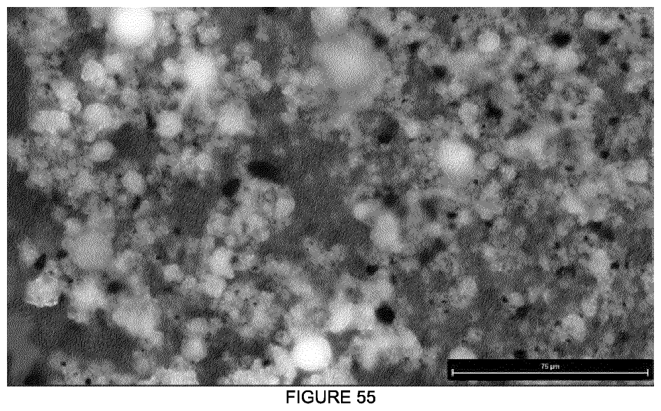

Solids from both control and CaPO samples were analysed via optical microscopy in FIGS. 54 and 55.

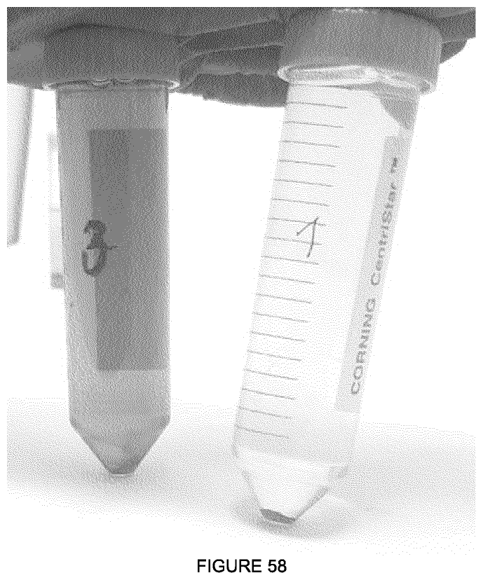

Washing of the solids was performed, as might be done in an industrial process in order to reduce the content of surfactant. Residual surfactants are known to be undesirable in many products. Washing was achieved by adding ˜0.3 ml of the solid slurries at the bottom of the sample containers into ˜50 ml of water. Despite the same volume of sample being washed, and the large volume of liquid used to wash the materials, the supernatant appeared dark in the control sample, where a whiteish pellet was seen at the bottom of the centrifuge tube. This is in stark contrast to the CaPO salt-flocculated sample, that appears to have no graphene in the supernatant (supernatant is clear) and a homogeneous grey solid pellet at the bottom of the centrifuge tube. FIG. 58 is a photograph of the two supernatants.

These results alone indicate that:
In the control sample, any ‘associated’ graphene in the settled solids has low cohesion to the PVDF, especially during washing conditions.
In the CaPO salt-flocculated sample from step 3, graphene and the PVDF are adhered together into a homogeneous solid, which resists separation during washing and centrifugation steps.

These results are corroborated by optical microscopy (FIGS. 54-57). While the control sample solids appears to contain some graphene material, it is mostly constituent of PVDF aggregates. Meanwhile, the CaPO salt-flocculated solids have higher graphene material distributed throughout the solids. The morphology and graphene content also appear to be maintained even after washing.

Order of graphene content in each sample, as is seen with optical microscopy in FIGS. 54-57:

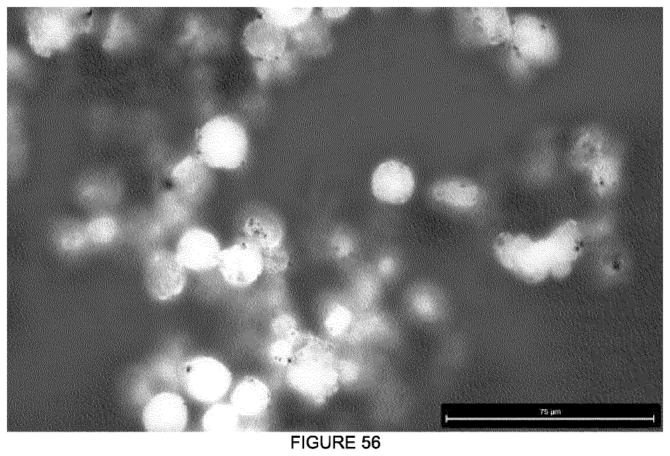

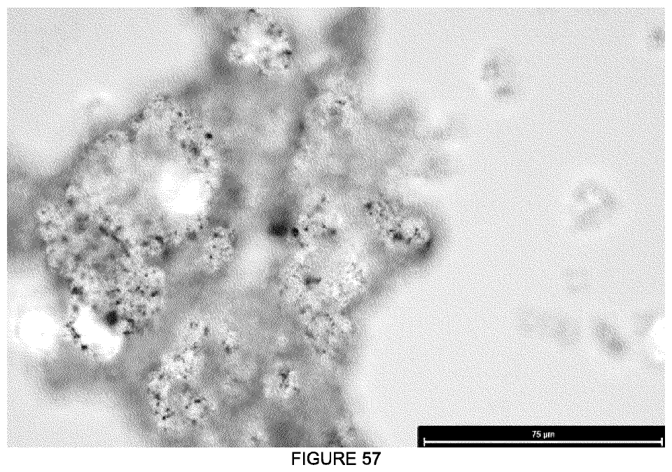

FIG. 54: Washed control; <FIG. 55: unwashed control<<FIG. 56: washed salt<FIG. 57: unwashed salt

1. A process for forming a composite, the process comprising the following steps:
a) providing a 2D material in a solvent;
b) adding a particulate material to the solvent;
c) providing a flocculating agent in the solvent, wherein the flocculating agent is a non-basic flocculating salt;
wherein the presence of the flocculating agent in the solvent results in an interaction between the particulate material and 2D material to form a composite.

2. The process according to claim 1, wherein the 2D material is selected from one or more of:
graphene, graphene oxide, reduced graphene oxide, functionalised graphene, partially oxidised graphene;
metal oxide nanosheets which are composed of sheets of edge/corner sharing MO₆ octahedra, (where M is a transition metal, and O is oxygen), where the sheets are separated by alkali metal cations, protons, water, solvent or any combination thereof;
metal double hydroxides which are composed of octahedral hydroxide layers of divalent and trivalent metal cations, where charge is balanced with anions between the layers, represented by the general formula M²⁺₁₋ₓM³⁺ₓ(OH)₂Aⁿ⁻_{x/n}.mH₂O (where M²⁺=Mg²⁺, Fe²⁺, Co²⁺, Ni²⁺, Zn²⁺, etc.; M³⁺=Al³⁺, Fe³⁺, Co³⁺, etc.; and A=(CO₃)²⁻, Cl⁻, (NO₃)⁻, (ClO₄)⁻, etc.);
hexagonal boron nitride; and
transition metal dichalcogenides with the general stoichiometry MX₂, where M is a transition metal atom and X is a chalcogen atom.

3. The process according to claim 1 or claim 2, wherein the 2D material is selected from hBN, graphene or a transition metal dichalcogenide.

4. The process according to any preceding claim, wherein the non-basic flocculating salt is selected from alkali hydrogen phosphates, ethyltriphenylphosphonium halides, Borax, non-basic ammonium salts, tetraethylammonium halides, alkaline earth metal nitrates, alkali metal nitrates, alkaline earth metal halides, alkali metal halides, MOF precursors and combinations thereof,
with the proviso that if the non-basic flocculating salt is ammonium chloride, it is formed in-situ in the solvent.

5. The process according to any preceding claim, wherein the non-basic flocculating salt is selected from one or more of sodium hydrogen phosphate, Ethyltriphenylphosphonium iodide, Borax, ammonium acetate, tetraethylammonium bromide, magnesium nitrate, lithium chloride, ammonium thiocyanate, zinc nitrate, diaminobutane, 2-methylimidazole, and combinations thereof.

6. A process for forming a composite, the process comprising the following steps:
a) providing a 2D material that is not graphene-based in a solvent;
b) adding a particulate material to the solvent;
c) providing a flocculating agent into the solvent, wherein the flocculating agent is a basic material, wherein the presence of the flocculating agent in the solvent results in an interaction between the particulate material and 2D material to form a composite.

7. The process according to claim 6, wherein the 2D material that is not graphene based is selected from:
metal oxide nanosheets which are composed of sheets of edge/corner sharing MO₆ octahedra, (where M is a transition metal, and O is oxygen), where the sheets are separated by alkali metal cations, protons, water, solvent or any combination thereof;
metal double hydroxides which are composed of octahedral hydroxide layers of divalent and trivalent metal cations, where charge is balanced with anions between the layers, represented by the general formula M²⁺₁₋ₓM³⁺ₓ(OH)₂Aⁿ⁻_{x/n}.mH₂O (where M²⁺=Mg²⁺, Fe²⁺, Co²⁺, Ni²⁺, Zn²⁺, etc.; M³⁺=Al³⁺, Fe³⁺, Co³⁺, etc.; and A=(CO₃)²⁻, Cl⁻, (NO₃)⁻, (ClO₄)⁻, etc.);
hexagonal boron nitride; and
transition metal dichalcogenides with the general stoichiometry MX₂, where M is a transition metal atom and X is a chalcogen atom.

8. The process of claim 7, wherein the 2D material that is not graphene is selected from hBN or a transition metal dichalcogenide.

9. The process of any of claims 6 to 8, wherein the basic material is a basic solution.

10. The process of any one of claims 6 to 9, wherein the basic material is a basic flocculating salt.

11. The process of any preceding claim, wherein the 2D material is present in the solvent as a dispersion.

12. The process of any preceding claim, wherein the 2D material and particulate material are substantially insoluble in the solvent at the operating temperature of the process.

13. The process according to any preceding claim, wherein the 2D material and particulate material are mixed prior to addition of the flocculating salt to form a dispersion.

14. The process according to any preceding claim, wherein the 2D material is provided by exfoliation of a bulk layered material in the solvent.

15. A process according to any one of claims 1 to 5, the process comprising:
a) providing a dispersion of a bulk layered material in a solvent;
b) adding a particulate material to the dispersion;
c) exfoliating the layered material, before or after the addition of the particulate material, to form a 2D material in the dispersion;
wherein the process comprises introducing a non-basic flocculating salt into the dispersion prior to or following any one of steps a) to c); wherein the presence of the flocculating salt to the solvent results in an interaction between the particulate material and 2D material to form a composite.

16. A process according to any one of claims 6 to 9, the process comprising;
a) providing a dispersion of a bulk layered material in a solvent;
b) adding a particulate material to the dispersion;
c) exfoliating the layered material, before or after the addition of the particulate material, to form a 2D material in the dispersion;
wherein the process comprises introducing a basic material into the dispersion prior to or following any one of steps a) to c); wherein the presence of the basic material in the solvent results in an interaction between the particulate material and 2D material to form a composite.

17. The process according to any one of claims 13 to 16, wherein the exfoliation comprises sonication, shear mixing, or high-pressure homogenisation, optionally at a shear rate of at least 10⁴s⁻¹.

18. The process of any one of claims 13 to 15 when ultimately dependent on claim 1, wherein the exfoliation of the bulk layered material is performed in the presence of a non-basic flocculating salt which also acts as an exfoliant.

19. The process of any one of claim 13 or 16 when ultimately dependent on claim 6, wherein the exfoliation of the bulk layered material is performed in the presence of a basic flocculating salt which also acts as an exfoliant.

20. The process of any preceding claim, wherein the particulate material and the 2D material are mixed together to form a dispersion.

21. The process of any one of claim 1 to 5 or 9, wherein the flocculating salt is generated in the solvent in-situ by transforming a source of salt into a flocculating salt by any one or more of: heat, pressure, reaction of an acid with a base, reaction with non-salts, reaction with precursor salts, catalysis, enzymes or light.

22. The process of claim 20, wherein the flocculating salt is generated in the solvent by;
adding two or more precursor salts to the solvent,
adding an antisolvent to the solvent, wherein addition of the antisolvent causes the precursor salts to react and form the flocculating salt in the solvent.

23. The process of any preceding claim, wherein the solvent comprises one or more of organic solvents and water.

24. The process of claim 23, wherein the solvent is selected from Cyrene; DMSO;
NMP; butyl lactate; dimethyl isosorbide; triacetin; DMF; 1,2-dichlorobenzene;
benzonitrile; pyridine; triethyl citrate; THF, cyclohexanone; cyclopentanone; olefins including pentane, hexane, cyclohexane, heptane, cyclooctane; ethyl acetate; ethyl lactate; furfual; eugenol; isoeugenol; levulinic acid; chloroform; 1,2-dischloromethane; toluene; methyl-t-butyl ether; methyl ethyl ketone; trichloroethylene; xylene; IPA; Water; Acetone; Methanol The process of claim 22 or 23, wherein the solvent is selected from Water, dichloromethane, chloroform, pentane, hexane, IPA, methanol, toluene, ethyl acetate, trichloroethylene, xylene, acetone, and combinations thereof.

25. The process of any preceding claim, wherein the particulate material is a metal oxide.

26. The process of any one of claims 1 to 25 wherein the particulate material is a polymeric material.

27. The process of any preceding claim, wherein the composite is dried following flocculation.

28. The process of any preceding claim, further comprising removing and/or recovering the flocculating salts present in the solvent.

29. The process of any preceding claim, wherein the process is performed in the absence of a surfactant.

30. The process of any preceding claim, wherein the ratio of 2D material to particulate material in the solvent is 1:1000 by atom to 10:1 by atom.

31. A process as claimed in any one of the preceding claims, wherein the process is conducted at a temperature in the range 0° C. to 260° C., preferably 0° C. to 110° C., more preferably 0° C. to 50° C.

32. A process as claimed in any one of the preceding claims, wherein the particulate material has a particle size in the range 5 nm to 1 pm, preferably 10 nm to 500 nm, ore preferably 15 nm to 250 nm.

33. A process according to any one of the preceding claims, wherein the interaction between the 2D material and particulate material results in an increase in particle size of the formed composite relative to the particle size of the particulate material.

34. A composite obtained by, obtainable by or directly obtained by the process according to any of the preceding claims.

35. A composite comprising a 2D material, a particulate material and a solid salt.

36. The composite of claim 35, wherein the 2D material, particulate material and solid salt are attached to one another in a flocculated product.

37. The composite of claim 35 or 36, wherein the 2D material is graphene, the solid salt is a non-basic flocculating salt and the particulate material is a metal oxide.

38. The composite of claim wherein the particle size of the composite is from 10 to 1000 microns

39. A composite comprising a 2D material, a particulate material and a metal organic framework.

40. The composite of claim 39, wherein the 2D material, particulate material and metal organic framework are attached to one another in a flocculated product.
